(19) United States
(12) Patent Application Publication
(10) Pub. No.: US 2020/0236901 A1
(43) Pub. Date: Jul. 30, 2020

(54) ANIMAL INTERACTION DEVICES, SYSTEMS AND METHODS

(71) Applicants: Leo TROTTIER, San Diego, CA (US); Daniel KNUDSEN, San Diego, CA (US); Philip MEIER, San Diego, CA (US); Gary SHUSTER, Vancouver (CA)

(72) Inventors: Leo TROTTIER, San Diego, CA (US); Daniel KNUDSEN, San Diego, CA (US); Philip MEIER, San Diego, CA (US); Gary SHUSTER, Vancouver (CA)

(21) Appl. No.: 16/839,003

(22) Filed: Apr. 2, 2020

Related U.S. Application Data
(63) Continuation of application No. 15/402,174, filed on Jan. 9, 2017, now abandoned.
(60) Provisional application No. 62/418,111, filed on Nov. 4, 2016.
(60) Provisional application No. 62/359,203, filed on Jul. 7, 2016.
(60) Provisional application No. 62/340,987, filed on May 24, 2016.
(60) Provisional application No. 62/326,807, filed on Apr. 24, 2016.
(60) Provisional application No. 62/300,915, filed on Feb. 28, 2016.
(60) Provisional application No. 62/276,605, filed on Jan. 8, 2016.

(51) Int. Cl. A01K 5/02; A01K 29/00; A01K 15/02; G01J 5/00; H04N 7/18

(52) U.S. Cl. CPC A01K 5/0283; A01K 29/005; A01K 15/021; G01J 2005/0077; G01J 5/0025; H04N 7/181; A01K 15/027

(57) ABSTRACT

Devices, systems and methods for animal training, animal feeding, animal management, animal fitness, monitoring and managing animal food intake, remote animal engagement, behavioral training and animal entertainment are disclosed. Embodiments of the present invention provide devices, systems and methods for measuring a dog's energy expenditures and/or movements, and providing signals to the dog to engage in activities or games to earn food. In one aspect, one or more of the dog's activity level, age, weight, body mass, and/or other health information is utilized to determine an appropriate food intake level for the dog. By measuring the dog's activity, the amount of calories the dog needs and/or has utilized may be determined. By encouraging activity by the dog, the dog's health may improve, even if the dog's weight remains unchanged. Among other embodiments disclosed herein, various mechanisms capable of moderating animal noise and/or behavior are disclosed.

### CROSS-REFERENCE TO RELATED APPLICATIONS

This application is a continuation of, and claims priority to, U.S. application Ser. No. 15/402,174, filed Jan. 9, 2017, which claims priority pursuant to 35 U.S.C. § 119(e) to US Provisional Application Nos.: 62/276,605, filed Jan. 8, 2016; 62/300,915, filed Feb. 28, 2016; 62/326,807, filed Apr. 24, 2016; 62/340,987, filed May 24, 2016; 62/359,203, filed Jul. 7, 2016; and 62/418,111, filed Nov. 4, 2016, all of which are incorporated by reference herein in their entireties.

### FIELD OF INVENTION

The present disclosure generally relates to the field of animal/human interactions. More specifically, embodiments of the present invention relate to animal training, animal feeding, animal management, animal fitness and monitoring of animal fitness, incentivizing animals to maintain fitness, monitoring and managing animal food intake, animal monitoring, remote animal engagement, inter-animal remote interaction, integration of animal intelligence into home and other devices, and animal entertainment.

### BACKGROUND

Humans domesticated dogs beginning between 14,700 and 36,000 years ago. Humans domesticated cats beginning between 4,000 and 5,500 years ago. Food animals and less common pets were domesticated and/or kept captive starting hundreds or thousands of years ago, depending on the animal and the use.

Animals, including captive animals and especially domestic pets, spend thousands of hours each year unattended or in a house alone, often while their owners are away at work. Unlike humans, they have no inherent way to engage in cognitively challenging and healthy games, exercises, or activities. Nearly every part of an animal enclosure or household—from the size of the door to the height of the light switches to the shapes of the chairs, has been designed to accommodate people. Similarly, entertainment devices in most homes are designed to interact with people, and cannot easily be controlled or accessed by a domestic pet. In the wild, animals do not simply sit passively all day, yet characteristics of human-animal interaction have placed animals in situations where even the stimulation provided by their natural environment is absent. This problem is particularly acute where animals are left home alone. This problem also manifests in a reduction in physical activity and concomitant reduction in physical wellness.

There are more than 40 million households in the United States alone that include at least one dog, and more than 35 million that include at least one cat. Many of these animals suffer from boredom, inactivity, and cognitive underuse daily, and correspondingly, millions of owners feel guilty for leaving their animals alone for hours at a time, and millions of animals suffer unnecessarily.

Per the 2014 National Pet Obesity Awareness Day Survey, an estimated 52.7% of U.S. dogs, and an estimated 57.9% of U.S. cats are overweight or obese. Out of a population of approximately 83 million dogs and 95 million cats in the United States, more than 103 million pets are overweight or obese. The obesity epidemic among pets has at least two causes. The first is the failure of pet owners to properly monitor and manage food intake. The second is the failure of pets to obtain a proper amount of exercise. Because many professionals and others do not have the time to regularly walk their dogs or monitor food intake, and because of the characteristics of the environments humans provide for their domestic animals, these problems are persistent.

Managing obesity in humans has proven to be a nearly intractable problem because humans control their own feeding and activity. While devices exist to measure human activity, such as the Xbox Kinect, the Fitbit, Apple Computer's Health Kit, and others, such devices are often ineffectual because of the relative degree of freedom over activity and food intake that humans enjoy. Captive animals, by contrast, control much of their activity, but have their food intake managed by a human. While manual mechanisms are available for managing pet food intake (such as food logs), humans have had difficulty in utilizing them, whether for practical or emotional reasons. Thus, there is a need for a mechanism to manage animal weight and health that does not rely on manual human management and intervention.

The design of such mechanism, namely, an animal interaction device capable of offering and withdrawing food for an animal has certain challenges. One of these challenges is determining whether there is food in the dish.

A persistent problem in dispensing systems is the ability to dispense a single item, a fixed number of items, and/or a range of items. Certain solutions are disclosed in PCT/US15/47431, Spiraling Frustoconical Dispenser, which is incorporated herein by reference as though set forth in full.

Another problem is the entertainment, training, health, fitness, and food management of animals. Certain solutions are disclosed in U.S. provisional patent application 62/276,605 and in U.S. patent application Ser. No. 14/771,995, both of which are incorporated herein by reference as though set forth in full.

In addition, while an animal is home alone, it may develop habits or exhibit behaviors that are undesirable, such as barking. Even if the animal only barks in the absence of the owner, the barking may create problems with neighbors.

Animals frequently make noises, whether alone or not, that are undesirable. Dogs that bark too frequently and/or at an improper time and/or in response to events that are not related to safety are often considered a nuisance, and in some cases, the dogs are given away or put down. Barking also causes disputes between neighbors and has potential legal implications.

Accordingly, it is desirable to provide devices, systems and methods which overcomes these limitations. To this end, it should be noted that the above-described deficiencies are merely intended to provide an overview of some of the problems of conventional systems, and are not intended to be exhaustive. Other problems with the current state of the art and corresponding benefits of some of the various non-limiting embodiments may become further apparent upon review of the following description of the invention.

This document describes various embodiments. While the disclosure utilizes a domesticated dog as an exemplary animal, it should be understood that unless the context clearly requires otherwise, the term “dog” would also include other domesticated animals. Further, the methods, systems, and apparatus disclosed herein should also be understood as applicable to undomesticated animals unless such application would be contraindicated by conditions specific to undomesticated animals (for example, controlling the overall food intake of a wild animal is unreasonable unless the animal has been taken captive).

Where we utilize the term “CLEVERPET® Hub” herein, the term should be understood to include (but not necessarily require) elements of the technology described in U.S. patent application Ser. No. 14/771,995 and/or other devices with similar functionality.

### SUMMARY OF THE INVENTION

In one embodiment, a CLEVERPET® Hub is the sole mechanism for providing food for a dog. In one aspect, the CLEVERPET® Hub is operably coupled to a weight measurement device and/or a dog-borne device. The weight measurement device may include, for example, a scale set proximate to the CLEVERPET® Hub. The dog-borne device, while referenced in the singular, may include more than one component or device. This may also include a virtual dog-borne device, specifically, one that tracks behavior as if it is attached to the dog, such as an imaging system that can track the dog.

In one implementation, the dog-borne device is equipped in a manner capable of measuring the dog's energy expenditures and/or movement, such as via an accelerometer, GPS, or similar technology. In one aspect, the CLEVERPET® Hub provides signals for the dog indicating that the dog may engage in a game to earn food and/or that food is available for the dog.

In one aspect, one or more of the dog's activity level, age, weight, body mass index (“BMI”), and other health information is utilized to determine an appropriate food intake level for the dog. As described in greater detail herein, the caloric intake and burn rate may be utilized to moderate the availability of food to the dog.

One aspect of managing obesity in dogs is to encourage the dog to be active. By measuring the dog's activity, it is possible to determine the amount of calories that the dog has utilized. Furthermore, by encouraging activity by the dog, the dog's health will improve even if the dog's weight remains unchanged.

An animal interaction device capable offering and withdrawing food for an animal presents various challenges, one of which is determining whether there is food in the dish, whether some or all food presented has been eaten, and otherwise measuring consumption.

Taking the CLEVERPET® Hub as an example, a tray presents and removes food available to the animal. Whether, and how much, food has been consumed may be a critical data point in various aspects of the invention herein. A failure to measure consumption properly may result in mechanical malfunction (such as by overfilling a tray), training failure (such as by “rewarding” an animal with an empty tray), or other problems.

In one aspect, reflectivity of the food tray may be measured to determine how much of the surface of the tray is covered. Because the tray may become discolored over time, dirty, wet, or otherwise experience changes to reflectivity unrelated to whether food is on the tray, it may be desirable to calibrate or recalibrate the expected reflectivity ranges for different conditions. Reflectivity measurement may be utilized alone and/or in conjunction with weight measurement of the tray, weight measurement of the remaining food, visual measurement (such as image recognition), or other data.

There may be cases where multiple dogs are present in the same household and/or using the same CLEVERPET® Hub. In such a case, the dogs may be differentiated in one or more of a variety of ways. When differentiated, the information specific to that dog may be loaded or accessed, either locally, from a local area network, from a wide area network, or from storage, including in one implementation storage on the dog-borne device. Differentiation may be accomplished by reading signals, such as near field communication (“NFC”) or Bluetooth low energy (“BLE”) signals, from a dog-borne device, face recognition, weight, eating habits and cadence, color, appearance, or other characteristics.

Gauging the position and posture of an animal is an important aspect of directing animal behavior. Such position and/or posture may be measured utilizing various methods, alone or in combination, such as sensors on the animal's body, a computer vision system, a stereoscopically controlled or stereoscopically capable vision system, a light field camera system, a forward looking infrared system, a sonar system, and/or other mechanisms.

Certain aspects of the invention described herein may be implemented utilizing a touch screen. In one aspect, the touch screen is proximate to, or integral with, the CLEVERPET® Hub or similar device. The touch screen may initially be configured to imitate the appearance of an earlier generation of the CLEVERPET® Hub or similar device. The screen need not literally be a touch-sensitive screen, as interaction with the screen may also be measured utilizing other mechanisms, such as video analysis, a Kinect-like system, a finger (or paw, or nose) tracking system, or other alternatives.

Certain of the instant inventions utilize genetic engineering to insert one or both of light-sensitive genes and scent-generating genes into one or more organisms. When hit with light generally, or with one or more particular frequencies of light, the organism responds by activating one or more genes that release a scent, in many implementations, one perceptible to the target animal. The scent may be further modulated by activating more than one gene to generate a mixture of multiple scents.

In PCT/US15/47431, among other things, a spiral dispensing device is disclosed. In particular, in paragraph 12, a frustoconical housing adapted for rotation is disclosed, as well as “housing [that] features a novel spiral race extending from a first side edge engaged with the interior surface of the sidewall of an interior cavity of the housing, defined by the sidewall. The race extends to a distal edge a distance away from the engagement with the sidewall of the housing. So engaged, the race follows a spiral pathway within the interior cavity from the widest portion of the frustoconical housing, to an aperture located at the opposite and narrower end of the housing.”

Embodiments of the present invention improve on singulation.

Preventing a dog from barking is generally achieved by behavioral training from an expert trainer. In some cases, mechanical devices, such as ultrasonic speakers, or anti-bark collars, serve by pairing an aversive stimulus with barking. Among other inventions disclosed herein, various mechanisms capable of moderating animal noise and/or behavior are disclosed.

For various reasons, it is desirable to know the physical posture of an animal at a given time. For example, a dog with difficulty remembering to urinate outside may adopt a walking posture, walk to the corner, adopt a head-up posture, squat, and then urinate. Identifying that the dog has adopted a walking posture, walked to the corner, and adopted a head-up posture, for example, provides an opportunity to intervene, train the animal, or otherwise interact with the animal using the information made possible by the animal's posture. In addition, automated training regimens may be created if it is possible to measure the animal's position.

A variety of imaging devices, such as Forward Looking Infrared, may be utilized. A variety of methods for identifying animal posture, even in very furry animals, are also described.

The interactions that dogs have with each other are often quite different from the interactions humans have with dogs or other humans.

As the CLEVERPET® Hub and other interactive pet devices become more common, it is desirable to create games and activities that dogs find suitable and interesting. Disclosed here are how certain devices, such as network-connected CLEVERPET® Hubs, may be utilized to facilitate play between dogs. In various implementations, the dogs may be proximate to each other, such as using a single hub jointly, or remote from each other.

Until now, humans have developed the toys and games we use with dogs. Dogs play with other dogs, but until now have not been able to program the toys and games that humans provide them.

Among other unique elements, in one aspect the inventions enable dogs to modify an interaction device. In this way, one or more animal interaction devices will adapt to the method by which animals interact with it. For example, there may be a category of “elderly dogs 25 to 50 kg” (a “cohort”). Within that category, the dexterity and speed of the dogs may be substantially different than other categories, such as “young dogs 5 to 10 kg”. It should be understood that a cohort may be large (i.e. “all dogs”), highly targeted (i.e. “border collies 10 to 15 kg age 1 to 2”), or somewhere in between.

In one aspect, no initial interaction patterns are pre-programmed, and as various dogs within a cohort interact with the device, the device records the interaction. Using a heuristic algorithm, modal interactions, average interactions, or other measurements, the system learns a set of interactions that dogs within that cohort engage in. Those interactions, or a variant thereon, may then be utilized as a target behavior for rewarding or otherwise interacting with other animals within that cohort (or, in some aspects, within similar or dissimilar cohorts).

In another aspect, initial interaction patterns are pre-programmed, and as various dogs within a cohort interact with the device, the device records the interaction. Using a heuristic algorithm, modal interactions, average interactions, or other measurements, the system learns a set of interactions that dogs within that cohort engage in. Those interactions, or a variant thereon, may then be utilized to modify the pre-programmed target behavior for rewarding or otherwise interacting with other animals within that cohort (or, in some aspects, within similar or dissimilar cohorts).

### BRIEF DESCRIPTION OF THE DRAWINGS

The instant patent application files contains at least one drawing executed in color. Copies of this patent or patent application publication with color drawings(s) will be provided by the Office upon request and payment of the necessary fee.

FIG. 1 is a schematic overview of certain functions of a CLEVERPET® Hub.

FIG. 2 is a schematic overview of a CLEVERPET® system.

FIG. 3 is a schematic view of a dog interacting with a CLEVERPET® Hub while an image is captured by a remote camera.

FIG. 4 is a perspective view of a CLEVERPET® hub.

FIG. 5 is a flowchart illustrating a method for determining appropriate food intake and dispensing food to achieve appropriate food intake.

FIG. 6 is a flowchart illustrating a method for determining the nutritional information about food inserted into the CLEVERPET® Hub.

FIG. 7A is a flowchart illustrating a method for sending a cue to a dog to encourage reaching an activity threshold.

FIG. 7B is a flowchart illustrating a method for enabling feeding based on a dog exceeding an activity threshold.

FIG. 8 is a flowchart illustrating a method for identifying an amount of food to feed a dog based on the characteristics of the dog food, calories burned and calories required.

FIG. 9 shows multiple CLEVERPET® Hubs in communication with each other.

FIG. 10A shows a presentation platform of a CLEVERPET® Hub, a food tray and food in the food tray.

FIG. 10B illustrates measurement of the reflectivity of a food dish.

FIG. 11 is a CLEVERPET® Hub with the cover removed to show a spiral dispensing device.

FIG. 12A shows a perspective view of a spiral dispensing device.

FIG. 12B shows a section view of the spiral dispensing device of FIG. 12A.

FIG. 13 is a flowchart illustrating a method for modifying behavior of a dog based on a method of providing rewards.

FIG. 14 is a drawing of a dog with various background elements demonstrating some of the issues in posture identification.

FIG. 15 is a Forward Looking Infrared (“FLIR”) image of the head and part of the body of a dog.

FIG. 16 is a visible light spectrum image of a dog including background elements.

FIG. 17 is a computer-generated combination of a visible light camera and a FLIR camera (“FLIR ONE”) image of a dog's face and a portion of its body.

FIG. 18 is a FLIR ONE full body image of a dog wearing a dog coat.

FIG. 19 is a FLIR image of a cat.

FIG. 20 is a FLIR ONE image of a human.

FIG. 21A is an outline view of a dog in a first position showing elements that may be used for posture identification.

FIG. 21B is an outline view of the dog of FIG. 21A in second position showing elements that may be used for posture identification.

FIG. 21C is an outline view of the dog of FIG. 21A in a third position, showing additional elements for posture identification.

FIG. 21D is an outline view of the dog of FIG. 21A in a fourth position, showing additional elements for posture identification.

FIG. 22A is a skeletal view of a dog in the first position of FIG. 21A.

FIG. 22B is a skeletal view of the dog of FIG. 22A in the second position of FIG. 21B.

FIG. 22C is a skeletal view of the dog of FIG. 22A in the third position of FIG. 21C.

FIG. 22D is a skeletal view of the dog of FIG. 22D in the fourth position of FIG. 21D.

FIG. 23A is an outline view of a dog in a first position showing regions that may be used to identify features and posture of the dog.

FIG. 23B is is an outline view of the dog of FIG. 23A in a second position showing regions that may be used to identify features and posture of the dog.

FIG. 23C is a mathematical representation of regions/features utilized for identifying posture of a dog at a given point in time.

FIG. 23D is a schematic representation of changes over time to regions utilized for identifying the posture of a dog.

FIG. 24 is a flowchart illustrating a method for modeling the features of an animal.

### DETAILED DESCRIPTION

Reference will now be made in detail to various embodiments of the invention, examples of which are illustrated in the accompanying drawings. While the invention will be described in conjunction with the following embodiments, it will be understood that the descriptions are not intended to limit the invention to these embodiments. On the contrary, the invention is intended to cover alternatives, modifications, and equivalents that may be included within the spirit and scope of the invention as defined by the appended claims. Furthermore, in the following detailed description, numerous specific details are set forth in order to provide a thorough understanding of the present invention. However, it will be readily apparent to one skilled in the art that the present invention may be practiced without these specific details. In other instances, well-known methods, procedures and components have not been described in detail so as not to unnecessarily obscure aspects of the present invention.

Additionally, in view of the exemplary systems described herein, methodologies that may be implemented in accordance with the disclosed subject matter can be understood with reference to the various figures. While for purposes of simplicity of explanation, the methodologies are described as a series of steps, it is to be understood and appreciated that the disclosed subject matter is not limited by the order of the steps, as some steps may occur in different orders and/or concurrently with other steps from what is described herein. Moreover, not all disclosed steps may be required to implement the methodologies described hereinafter.

Management of Animal Health, Weight, Activity

Embodiments of the instant invention relate to management of animal health, weight and activity.

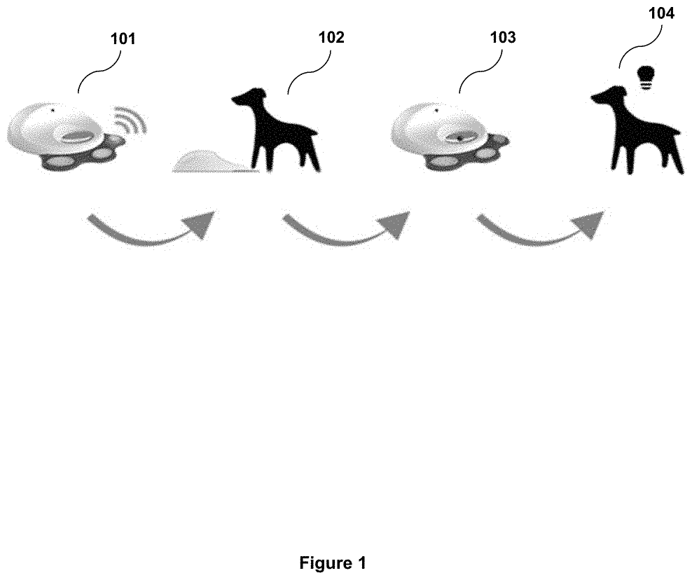

Referring to FIG. 1, therein is shown an overview of certain functions of one embodiment of the present invention. A CLEVERPET® Hub or other feeding device (in one aspect, a metered feeding device) is utilized as the sole (or primary) mechanism for providing food for a dog. At step 101, the Hub communicates with a dog. At step 102, the dog responds. If the dog's response is appropriate, at step 103, the CLEVERPET® Hub dispenses a treat 103, and at step 104 the dog learns that its response is appropriate, thereby getting more clever.

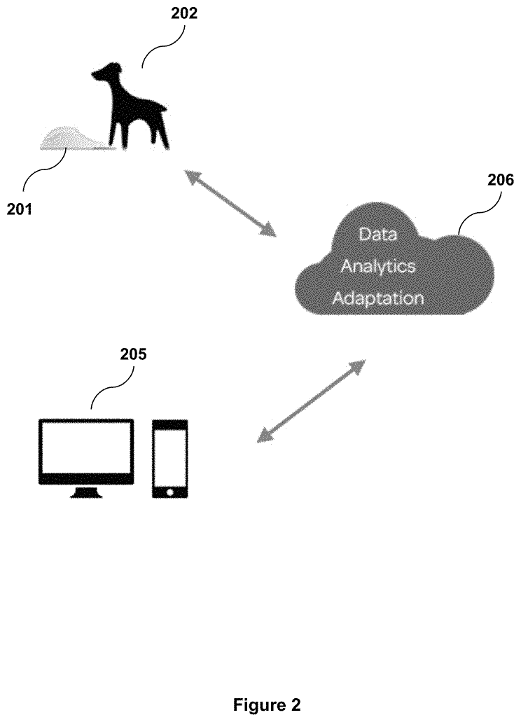

In its most basic form, a system for management of animal health, weight and activity is illustrated in FIG. 2. The system comprises a CLEVERPET® Hub 201, or similar metered feeding device, an animal 202, a user interface 205, and servers 206. The Hub 201 challenges the animal 202 and, when appropriate, rewards it with food. The Hub tracks the animal's progress and adapts to keep it engaged. The user interface may comprise a computer, portable computer, tablet, smartphone or similar device with a software application, a mobile software application or a connection to a dedicated website, allowing a user to check in to see how the animal is progressing, and in some instances, control the CLEVERPET® Hub 201. The servers 206 may store data, perform analytics and/or calculations, so as to determine, among other things, adaptations to the operation of the Hub 201 for continued engagement of the animal.

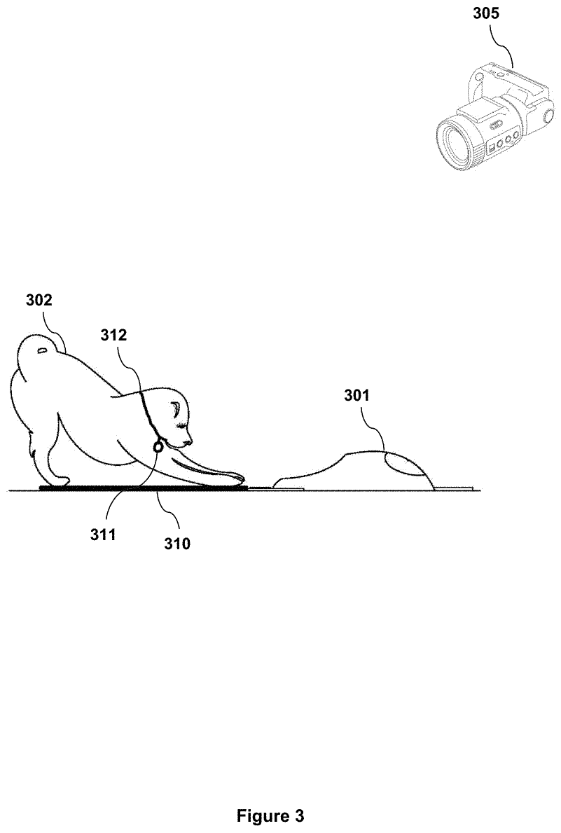

In one aspect, video data may be utilized to observe the dog obtaining and/or eating food from other sources, and such data may be analyzed by a computer. Such data may also be incorporated into one or more of the calculations. As illustrated in FIG. 3, the CLEVERPET® Hub 302 may be operably connected with a weight measurement device 310 and/or a dog-borne device 311. The weight measurement device 310 may include, for example, a pad set in front of the device capable of measuring the weight of the dog 302. One implementation may exclude or supplement an operably connected weight measurement device 310 in favor of a manually entered weight. Another implementation may utilize the dog's body mass index (“BMI”). Another implementation may utilize an integrated or remote camera 315 or other device to estimate the BMI, estimate the healthy weight of the dog, estimate the dog's length and weight, or gather other data. Such camera 315 may be in the visual light spectrum, far infrared, near infrared, non-visual light and/or radiation spectrum, and/or a 3D imaging device such as an Xbox Kinect. The dog-borne device 311 may take the form of a device attached to the leg of the dog, the collar of the dog 312, or otherwise. It should be understood that the dog-borne device 311, while referenced in the singular, may include more than one component, such as a collar device 312 and an imaging system 315, a leg-borne device (not shown) and/or a tail-borne device (also not shown).

Furthermore, in another implementation the dog may be equipped with a virtual dog-borne device 311 in the form of an imaging system 305 that tracks the dog. In another aspect, the dog-borne device 311 may be connected with the CLEVERPET® Hub 301 via Bluetooth, Bluetooth Low Energy (“BTLE”), WiFi, near field computing, infrared, radio, or other communications modalities. In one aspect, where the dog is out of range of the CLEVERPET® Hub, the device may communicate over a wide area network (“WAN”) and/or may store data and send it to the CLEVERPET® Hub 301 when the device returns to an area within range of the CLEVERPET® Hub 301. Alternatively, or in addition, a mesh network or peer-to-peer transmission system may be utilized, as may a system where data can be reported to a variety of receivers not directly associated with the dog 302, in a manner similar to the Tile device (as described at http://www.thetileapp.com, last visited on Dec. 21, 2016).

In one implementation, the dog-borne device 311 is equipped in a manner capable of measuring the dog's energy expenditures and/or movement. For example, the amount, cadence, speed, movement and magnitude of a dog-borne device 311 in the form of the collar 312 may be utilized to determine whether the dog is moving, resting, or engaging in other various behaviors (examples might include sleeping, walking, running, playing, fighting, etc.). The measurement may be made utilizing one or more of a variety of techniques, including imaging, sound measurement, accelerometers, sound of breathing (including rate and noise), perspiration measurement (done at a location where the animal perspires), body movement, such as tail wagging, body twisting (whether associated with tail wagging or otherwise), chewing, drinking, heart rate measurement, blood oxygenation, body temperature, etc. In one aspect, the dog-borne device may also include a water sensor (whether implemented as a circuit that is closed by the presence of water or otherwise). The actuation of the water sensor may be utilized to determine whether the animal is swimming, simply wet, or in some other status. The water sensor may be utilized in conjunction with motion sensors and/or other sensors to determine which of the activities associated with a wet dog is being engaged in. In one aspect, the presence of water and/or ambient temperature of water and/or air on or around the dog may be utilized, optionally in conjunction with an analysis of fur characteristics such as length and thickness, to determine caloric cost of maintaining body temperature.

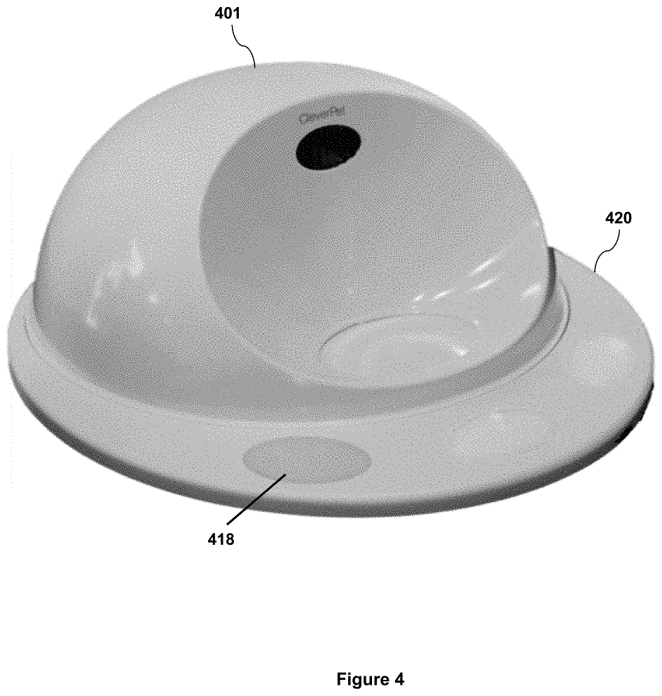

In one aspect, the CLEVERPET® Hub 401, as shown in FIG. 4, provides signals for the dog indicating that the dog may engage in a game to earn food and/or that food is available for the dog. Such signals may take the form of noises that naturally occur during the process of feeding or preparing the CLEVERPET® Hub 401 for feeding, such as the sound of food entering a chamber. In another aspect, the CLEVERPET® Hub 401 provides light signals through pad 418 located on the Hub 401 and/or sound, movement, and/or smell signals associated with feeding. These signals, together with other signals emitted by the dog-borne device (e.g., device 311 of FIG. 3), are referenced herein as “Associative Cues”.

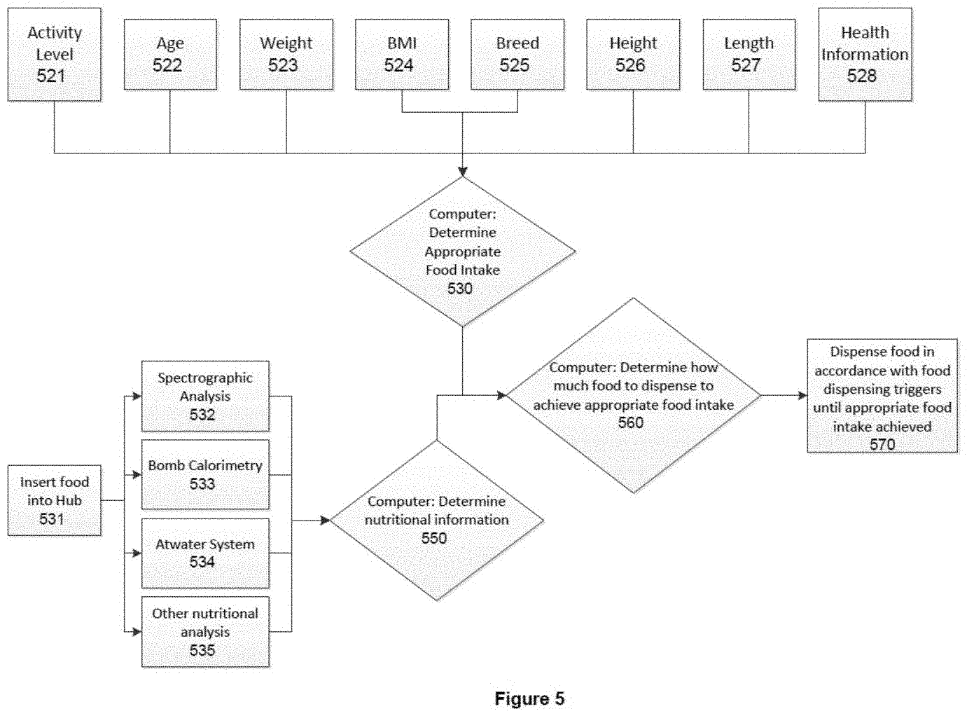

In one aspect, and as shown in the flowchart of FIG. 5, one or more of the dog's activity level 521, age 522, weight 523, Body Mass Index (“BMI”) 524, breed 525, height 526, length 527, and other health information 528 is utilized to determine, at step 530, an appropriate food intake level for the dog. The determination may be made based on a calculation of the amount of calories required by the dog. In one implementation, spectrographic analysis 532, bomb calorimetry 533, the Atwater system 534, or other nutritional analysis 535 of the food loaded into the CLEVERPET® Hub is used to determine, at step 550, the nutritional content and/or other nutritional characteristics of the food. At step 560, the appropriate food intake 530 and nutrition information 550 may be used to determine how much food should be dispensed to achieve appropriate food intake. At step 570, the CLEVERPET® Hub may then be used to dispense food in accordance with animal training and/or interaction and/or other dispensing triggers until appropriate food intake 560 is achieved.

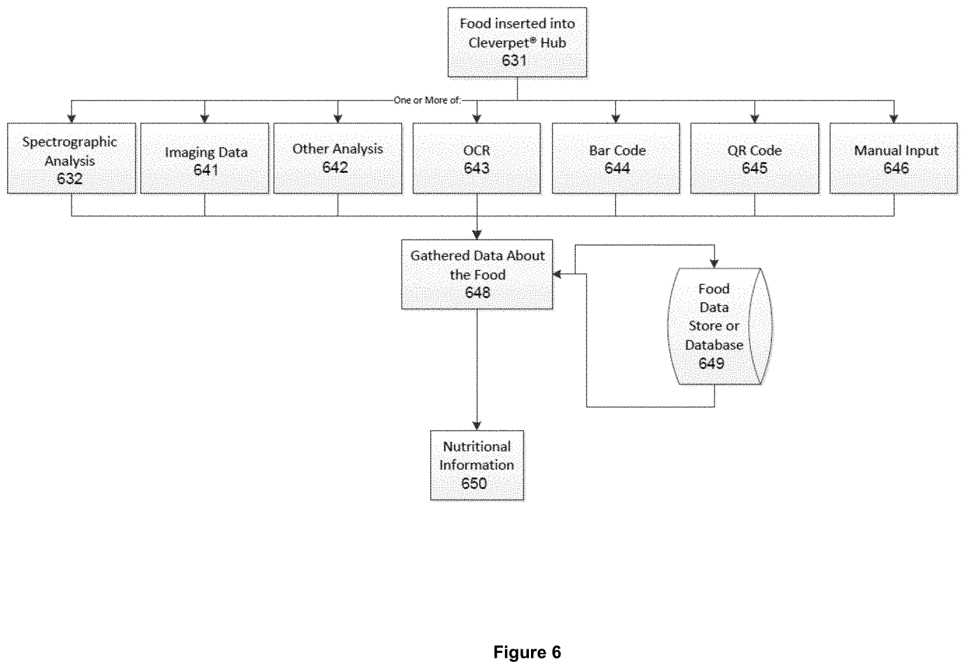

In another aspect, a method of determining the nutritional information, as shown in FIG. 6, comprises, at step 631, food is inserted into the CLEVERPET® Hub. At steps 632 spectrographic data is obtained and/or provided, and at steps 641 and 642, respectively, imaging data, and/or other analysis is obtained, provided and/or performed. At steps 643 through 646, in conjunction with spectrographic data, matching spectrographic data to a database, and/or other analysis, or independently, the brand and type of food inserted may be measured, such as by OCR 643, bar code reading 644, QR Code reading 645, or by manual input 646. At step 648, such information about the food may be gathered and/or combined, and such data/information may be compared to data/information stored in a database 649 or other data store, and at step 650, such comparison may be utilized to identify the food based on the gathered data at step 648 about the food.

For example, a user may scan a barcode or indicate manually she is feeding her dog “Jim's Patent Brand Dog Food for Older Dogs”. The CLEVERPET® Hub or other device would then look up the nutritional information for such food utilizing a networked database and/or data stored locally. This database, as shown in FIG. 6, is a single database, though it may be a plurality of databases and/or a separate database. In one aspect, partial information, such as a brand (e.g. “Purina”) may be combined with analysis by the CLEVERPET® Hub 631, such as measurement of color and size of kibbles, to determine which of the various Purina dog foods has been loaded. In instances where there is an intermixing of food types, optical or other analysis may be utilized as the food is loaded, after the food has been loaded, as the food is prepared for being dispensed, or as the food is dispensed, to determine the average or actual nutritional characteristics of the food. In one aspect, the food actually dispensed is measured and is considered as eaten unless the food is returned to the device, uneaten. In another aspect, the food may not be considered eaten unless the dog-borne device (e.g., the dog-borne device 311 in FIG. 3) and/or the CLEVERPET® Hub 631 determine that the motion and/or sound associated with chewing and/or swallowing has taken place.

In another aspect, and as discussed with regard to FIG. 5, the CLEVERPET® Hub 531 or other food dispenser may conduct caloric and/or nutritional analysis. For example, bomb calorimetry 533, the Atwater system 534, and/or other methods of measuring nutritional data 535 may be utilized. In one aspect, the nutritional content may be modified based on video or other analysis indicating how well the dog chews the food. Similar analysis may be made of the dog's fecal matter to determine how many of the available calories or other nutritional elements were expelled as waste.

One aspect of managing obesity in dogs is to encourage the dog to be active. By measuring the dog's activity, it is possible to determine the number of calories that the dog has utilized. Furthermore, by encouraging activity by the dog, the dog's health will improve even if the dog's weight remains unchanged.

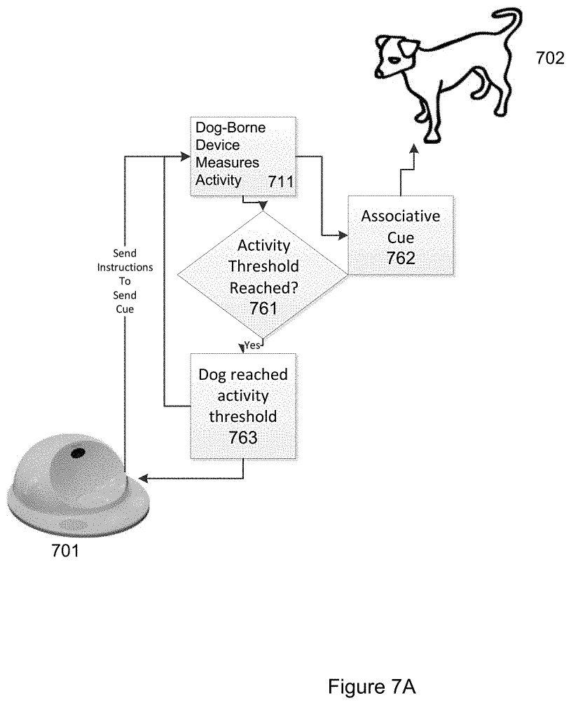

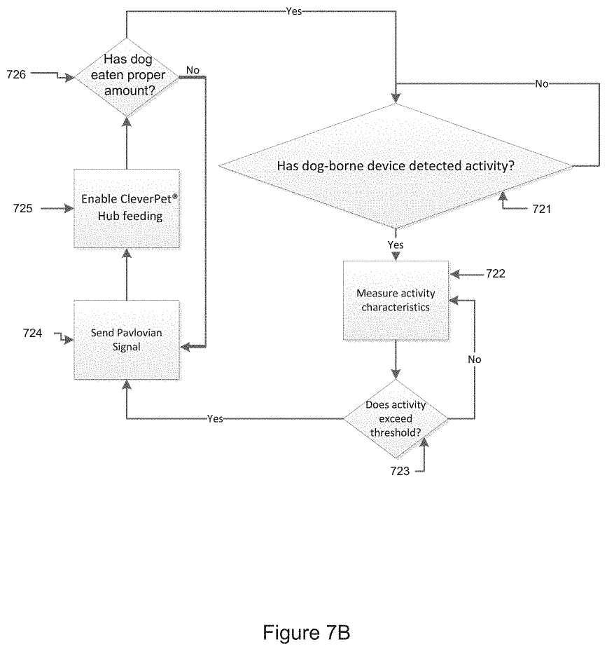

As shown in FIG. 7A, in one implementation, a method for managing obesity in a dog comprises, at step 711, measuring the activity of a dog 702 using a dog-borne device. At step 761, the activity of the dog is compared to an activity threshold to determine if an activity threshold is met. If the activity threshold is not met, at step 762, an Associative Cue is sent to the dog 702 encouraging the dog to exercise, and subsequently, again at step 711, a dog-borne device measures the activity of the dog 702. In some instances, the dog-borne device sends the Associative Cue by itself. In other instances, the Associative Cue may be sent by the dog-borne device and/or by signaling the CLEVERPET® Hub 701 to send the Associative Cue after a period of activity.

In one implementation, the signal is not sent until after the dog's activity has stopped. In another, the signal is sent after a set amount of activity across discontinuous time periods. In another, the signal is sent after a set amount of activity across a continuous time period. In another, the signal is sent after a set amount of calories have been burned, either across a continuous time period or a discontinuous time period.

In the embodiment of FIG. 7B, a method for balancing activity and feeding is shown. At step 721, a dog-borne device (or other device) detects whether there has been activity by the dog. If not, the device continues to check for such activity. If activity has been detected, at step 722, the characteristics of the activity are measured. The characteristics of the activity may include, but are not limited to, type, intensity, time period, time of day, continuous or noncontinuous nature, in some aspects, calories burned (whether calculated, estimated or measured), etc. At step 723, it is determined whether the activity exceeds an activity threshold. The threshold may be determined programmatically using an algorithm based on the dog's age, weight, BMI, breed, health, etc., or may be manually input by an operator, including the dog's owner. If the activity threshold has not been met, activity characteristics continue to be measured. If the activity threshold has been met, at step 724, a pavlovian signal is sent, and at step 725, feeding by the CLEVERPET® Hub (e.g. Hub 701 of FIG. 7A) or similar device is enabled. At step 726, the Hub or similar device determines whether the dog has eaten the proper amount. If the dog has not yet eaten the proper amount, the steps 724, 725 and 726 are repeated until the proper amount of food has been ingested by the dog. If, on the other hand, the dog has eaten the proper amount, the method begins again at step 721 and the dog-borne device (or other device) detects whether there has been activity by the dog.

In one implementation, a calculation is made as to the amount of calories that the dog should eat (e.g., by consideration of factors 521 through 528 as shown in FIG. 5). The number of calories may be increased by the amount of calories burned via activity level 521. This calculation may be made to increase the dog's weight 523, if underweight, maintain the dog's weight 523 if already at an appropriate weight, or decrease the dog's weight 523 if overweight. In certain situations, such as fattening a domestic food animal, the calculation may be made to cause weight gain even when the animal is overweight or at a healthy weight. In a situation involving a lactating animal, food intake may be modified by estimating the number of additional calories (and/or other nutrients) needed for lactation. In one aspect, a video analysis may be utilized to determine and/or estimate the amount of milk consumed from the lactating animal. In another aspect, a direct measurement (as in the case of a cow being milked by a machine) may be made.

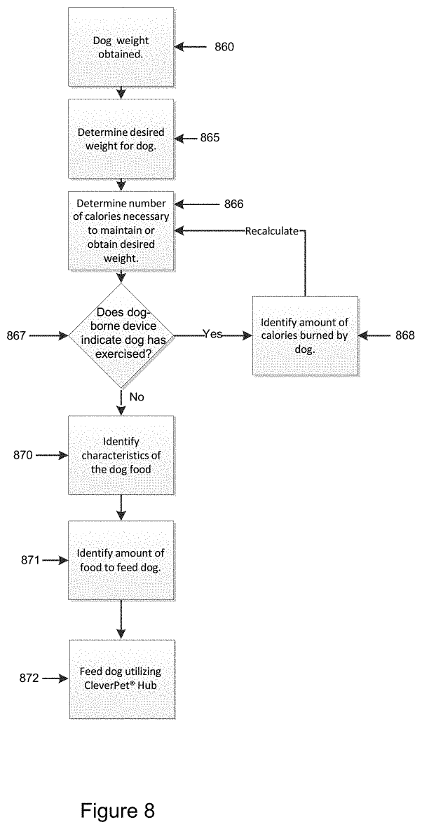

An embodiment of a method for animal feeding is illustrated in FIG. 8. At step 860, the weight of the dog is obtained. The weight may be obtained by devices and methods as described with regard to FIG. 3 above. At step 865, the desired weight of the dog is determined. Desired weight may be determined by comparison (automatic or otherwise) to a database of appropriate weights for dogs of a certain breed, age, height, length, etc., or may be input manually by the operator or dog's owner. At step 866, the number of calories necessary to maintain or obtain desired weight is determined (e.g., as described with regard to step 530 of FIG. 5). At step 867, a dog-borne device (or other device(s)) determines whether the dog has exercised. If the dog has exercised, at step 868, the amount of calories burned by the dog is determined (e.g., as described with regard to step 722 of the method of FIG. 7B above), and the number of calories necessary to maintain or obtain the desired weight is recalculated. If the dog has not exercised, at step 870, the characteristics of the dog food are identified (e.g., as described with regard to 532-535 and 550 of FIG. 5). At step 871, the amount of food to feed the dog is determined (e.g., as described with regard to step 560 of FIG. 5), and at step 872, the dog is fed utilizing the CLEVERPET® Hub or other, similar device.

In one aspect, a machine learning system, such as a multi-level neural network, a Bayesian system, or otherwise, is utilized to correct predicted calorie and weight loss scenarios. For example, a dog may have a metabolism that is 20% slower than predicted. In addition, weight, food intake, and/or activity level may be measured over time and that data utilized in conjunction with machine learning to determine the metabolic rate of the animal and/or other data about the animal. Over the course of several months, the system will determine that the dog is not losing weight at the predicted rate and further decrease the number of calories of food dispensed and/or increase the incentives for and/or frequency of utilization of exercise and/or activity-encouraging functions of the device(s).

The results of the calculation are utilized to determine how much food the dog will receive over a given time period. For example, if a dog normally receives 1,000 calories of food to maintain her weight and is already at a healthy weight, the dog may be dispensed 1,200 calories of food on a day she runs a lot. In one aspect, all feeding is done via the CLEVERPET® Hub (e.g., Hub 401 of FIG. 4. In another aspect, the dog-borne device (e.g., the dog-borne device 311 of FIG. 3), imaging systems, manual input, and/or a combination of those mechanisms, may be utilized to determine how much food the dog has eaten outside of the CLEVERPET® Hub system, and the amount distributed by the CLEVERPET® Hub modified to maintain a proper amount of food consumption. Such determination may be made, for example, by image analysis, manual input, or otherwise.

In another aspect, and as shown in FIG. 9, multiple CLEVERPET® Hubs 901A-901D may communicate with each other through signals 965A-D, encouraging the dog to run or walk between Hubs 901A-901D as a mechanism to increase exercise, whether in conjunction with a dog-borne device or otherwise. In one aspect, sounds are emitted from one or more hubs to attract the dog to that hub. When the dog interacts with that hub (or becomes proximate to the hub), a sound may be emitted from another hub, drawing the dog there. In this way, the dog may be made to move around a house, yard, or other place. It should be noted that the sounds and devices need not be CLEVERPET® Hubs but may be virtual hubs created by projecting sound to a place and monitoring a video feed for that place, may be cameras capable of making sounds, or other devices. While we use the term “sound” herein, as that is a common modality for gathering animal attention, it should be understood that lights, scents, or vibration may also be utilized. In another aspect, a pressure-sensitive pad, or series of pressure-sensitive pads, may be utilized in conjunction with a reward system to encourage pet activity.

There may be cases where multiple dogs are present in the same household and/or using the same CLEVERPET® Hub. In such a case, the dogs may be differentiated in one or more of a variety of ways. When differentiated, the information specific to that dog may be loaded, either locally, from a local area network, from a wide area network, or from storage on the dog-borne device. Differentiation may be accomplished by reading signals, such as NFC or BLE signals, from a dog-borne device, face recognition, weight, eating habits and cadence, color, appearance, or other characteristics.

In one aspect, a single device (or a group of devices operably connected either to a server or peer-to-peer or to a database or to a data store for data sharing) may serve a plurality of animals. In the case where the animals are differentiated (which differentiation may require a set confidence interval to validate that the identity of the animal), the caloric and nutritional management features of the inventions may be implemented on an animal-by-animal basis. For example, if Rover and Rex share a device and Rover has eaten all of his calories for the day, Rover may not be permitted to interact with the device while Rex may be permitted so long as Rex has calories remaining.

In one aspect, embodiments may take the form of an animal interaction apparatus, comprising: A plurality of signal devices (e.g., the Hubs 901A-901D of FIG. 9) capable of emitting a signal perceptible to an animal; the signal devices in communication with at least one coordinating device; the coordinating device in communication in communication with at least one reward dispensing device; where the coordinating device causes at least one of the signal devices to emit a signal perceptible to the animal; at least one detector selected from the group of an animal interaction device, a camera, a FLIR sensor, and a microphone; where at least one of the detectors detects when an animal has moved to a position more proximate to the at least one of the signal devices that emitted a signal perceptible to an animal; and causing the at least one reward dispensing device to dispense a reward.

In another aspect, at least one of the signal devices proximate to the animal emits a success signal substantially simultaneously with the dispensing of the reward. In another aspect, at least one of the reward dispensing devices emits a sound perceptible to the animal substantially simultaneously with the dispensing of the reward. In another aspect, at least one of the detectors is a camera. In another aspect, at least one of the detectors is a FLIR sensor. In another aspect, at least one of the detectors is a microphone. In another aspect, at least one of the detectors is an animal interaction device. In another aspect, at least one of the reward dispensing devices is also an animal interaction device. In another aspect, at least one of the signal devices is a reward dispensing device.

In one aspect, an animal exercise apparatus may comprise at least one reward dispensing device located in a structure; at least two cameras, at least two of which are located in the structure; a first one of the cameras located in a first room and a second one of the cameras located in a second room; detecting, using the first camera, that an animal is located in a first room; emitting a signal perceptible to the animal, using a signal emission device, a signal in the same room as a second camera; detecting, using the second camera, that the animal has entered the second room; and dispensing a reward, using the at least one reward dispensing device. It should be understood that structure may mean a house, a barn, or any other structure. Where we discuss a structure, it should be understood that implementation may also be achieved in a space other than a structure, such as a farm.

One another aspect, the reward is dispensed some, but not all, of the time that the animal travels from the first room to the second room subsequent to emission of the signal. In another aspect, the second camera is in the same room as the reward dispensing device. In another aspect, the first camera is in the same room as the reward dispensing device. In another aspect, at least one of the cameras or the reward dispensing device are controlled by an animal interaction device. One or more of the cameras may be network-connected. One or more of the cameras may be a Nest branded and/or manufactured and/or licensed camera.

In another aspect, one or more cameras, microphones or other sensors may be utilized to detect when an animal is engaging in a behavior that is undesirable or that should be disrupted. For example, a dog may be barking, eating a couch, digging holes in the yard, chewing a power cable, in a room that the dog should not or should no longer be in (for example, refusing to leave a bedroom at night), or simply inactive. In one aspect, the behavior is detected with one or more of the sensors. In another aspect, the behavior may be required to exceed N seconds, where N may be zero, 5, 10, or any other number (although denomination in seconds is not necessary, and when we use the term “seconds” to denote time, it should be understood that other time measurements are included, such as milliseconds, computer clock cycles, minutes, hours, or otherwise). When the undesirable or desirable-to-disrupt behavior is taking place, the dog exercise inventions described herein may be triggered either a single time, until the dog changes behavior, or multiple times. In one aspect, the disruption is achieved by triggering a pavlovian signal in a location that the system and/or user desires the dog to move to. For example, a dog chewing a power cord in a bedroom may be attracted to a food dispensing sound coming from a living room. In one aspect, only a single animal interaction device is required in combination with a mode of signaling the device to actuate. In another, multiple animal interaction devices and/or sensors may be utilized. In another, a negative reinforcing signal (such as a signal the animal has already been trained to perceive negatively, or a signal, such as a high pitched sound, that the animal will perceive negatively) may be utilized in combination with these inventions. In one aspect, the negative reinforcing signal is emitted proximate to the animal. In another, the negative reinforcing signal is emitted simultaneously, substantially simultaneously, or in sequence with a pavlovian positive signal. In one aspect, the negative signal may be emitted from a location more (or less) proximate to the animal than the pavlovian positive signal.

In a further aspect, it may be undesirable to reward the animal for undesirable behavior, such as chewing furniture (or, from the animal's perspective, appear to reward or otherwise associate positive consequences). To prevent the dog from associated the undesirable behavior with a reward, a random, pseudorandom, or variable noise may be utilized to draw the dog into a different location and/or to stop the behavior. The noise may emanate from any device operably connected to an animal interaction device, a CLEVERPET® Hub, and/or a system contained within or connected to the sensor that detects the undesirable behavior. In a further aspect, after N seconds from the dog leaving the location where the undesirable behavior was taking place, the dog may be engaged by the animal interaction device to distract the dog or otherwise reduce the likelihood that the dog will resume the undesirable behavior. N may be immediate, substantially immediate, 1 second, 5 seconds, 10 seconds, 15 seconds, or any other time period. In another aspect, this may be accomplished by utilizing the exercise routines described herein.

In another aspect, the inventions may include an animal exercise apparatus, comprising at least one reward dispensing device located in an animal-accessible area; at least one camera, at least one of which is located in the animal-accessible area; a first one of the cameras located in a first area; detecting, using the first camera, that an animal is located in a first area; emitting a signal perceptible to the animal, using a signal emission device, a signal in a second area; detecting, using an animal interaction device located in the second area, that the animal has interacted with the animal interaction device; and dispensing a reward, using the at least one reward dispensing device.

In another aspect, the at least one reward dispensing device is integral with the animal interaction device. In another aspect, dispensing of the reward is done only after the animal has successfully completed a specified interaction with the animal interaction device. In another aspect, the animal interaction device may be integral with the signal emission device. In another aspect, the animal is a domesticated pet. In another aspect, the animal is livestock. In another aspect, the animal-accessible area may be a farm, field, back yard, barn, house, apartment, condominium, kennel, veterinary hospital, animal exercise area, pet store, or other indoor or outdoor structure or any part thereof, or area.

Measurement of Food Dish Contents

Certain challenges exist in effectuating an animal interaction device capable of offering and withdrawing food for an animal. One of these challenges is determining whether there is food in the dish.

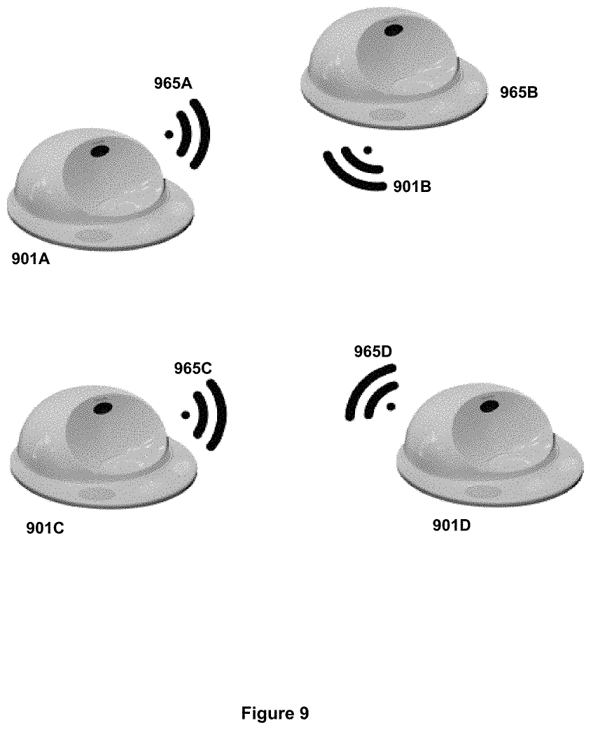

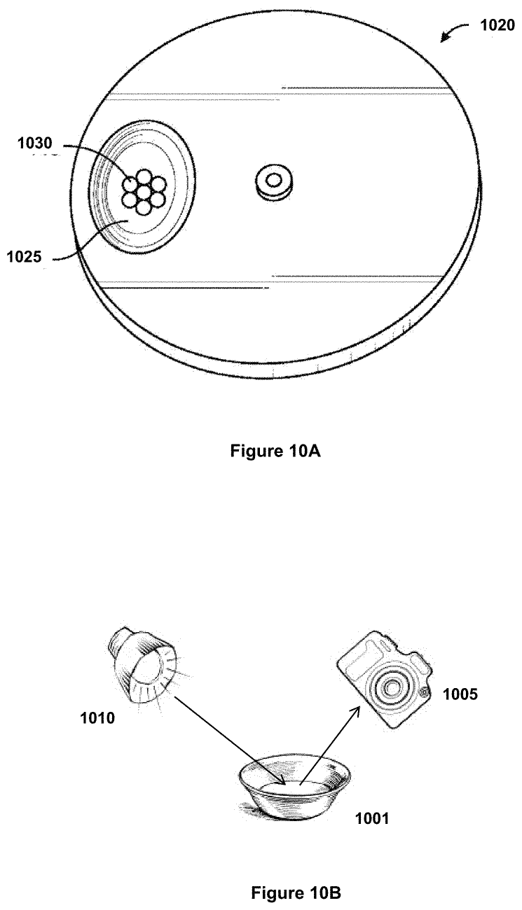

Referring now to FIG. 10A, in one embodiment, the CLEVERPET® Hub has a presentation platform 1020 (see also 420 of FIG. 4), which presents a food tray 1025 to the animal. Subsequently, the tray 1025 is withdrawn from presentation, sometimes based on interactions the animal has with the Hub. If a sufficient quantity of food 1030 remains in the tray 1025 after it is withdrawn from presentation, no food 1030 should be added to the tray 1025 before it is again presented. Indeed, in some designs, adding more food may cause the tray 1025 to be overfilled and thereby cause malfunctions in the device.

In one aspect, reflectivity of the food tray may be measured to determine how much of the surface of the tray is covered. As shown in FIG. 10B, in some instances, the reflectivity may be measured by shining a light source 1010 of known intensity on the surface of a food tray 1001, and measuring the reflectivity utilizing a digital camera 1005 or other measurement device. Because the tray may become discolored over time, dirty, wet, or otherwise undergo changes to reflectivity unrelated to whether food is on the tray, it may be desirable to calibrate or recalibrate the expected reflectivity ranges for different conditions. It may also be desirable to utilize one or more specific light wavelengths in order to reduce the risk of false positives or false negatives.

For example, a dish may leave the factory reflecting 80% of the light in the violet 405 nm wavelength and 70% of light in the 808 nm green wavelength. However, dog saliva may absorb more of the light in the lower wavelengths than in the higher wavelengths. Accordingly, by utilizing two or more different wavelengths, it may be possible to infer the contents of the dish in whole or in part. Thus, for example, a very high level of absorption of red wavelengths and a low level of absorption of green and/or blue wavelengths may indicate a wet dish and trigger a drying and/or cleaning function. The drying and/or cleaning function may be terminated based on time, conductivity, and/or changes to light reflectivity. Similarly, a measurement of the polarization of the reflected light may be utilized to determine the amount of water or other liquid on the dish.

In another aspect, the expected rate of change for moisture may be utilized to add accuracy and/or to modify the formula used to determine moisture. Ambient integral and/or external temperature and/or humidity sensors may be utilized to improve the accuracy of the predicted rate of change. In another aspect, a control bowl may be utilized whereby the rate of evaporation may be directly measured. In another aspect, the bowl may be weighed and the weight compared to the empty weight from the factory and/or the base weight from an earlier time, and the weight used to infer the amount and/or presence of bowl contents. Such data may be used alone or in conjunction with the other data gathered as described herein.

Directing Animal Behavior

There are various embodiments disclosed herein for directing animal behavior.

Such embodiments may identify or estimate, or assist in identifying or estimating, the position and/or posture of an animal. Such position and/or posture may be measured utilizing various methods, alone or in combination, such as sensors on the animal's body, a computer vision system, a stereoscopically controlled or stereoscopically capable vision system, a light field camera system, a forward looking infrared system, a sonar system, and/or other mechanisms. It should be appreciated that a sonar system should be modulated in tone and/or volume to avoid being disturbing and/or audibly detectable by the animal. Methods for identifying position and posture of an animal are further discussed in detail in sections that follow.

With regard to directing animal behavior, in one implementation, the system is designed to first teach the animal that sound is relevant and/or meaningful. When the animal is present, the system may teach sound relevance by having a sound stimulus shift along a particular dimension, and when it reaches some target parameter, the system releases some reward. In many cases, the reward will be food, as most animals are already interested in having food rewards. When used herein, and unless the context clearly requires otherwise, the term “reward” should be understood as including both food and non-food rewards.

Once the animal has associated the parameter shift with the reward, the system may indicate that it is ready to engage the animal. In one aspect, this may be accomplished by “calling” the animal over with a tone. In another aspect, vibration outside of the audible range, sound, light, scent, or a combination of two or more of these may be utilized. Once the system can observe the animal, the system responds to the animal's movements. It should be noted that the term “observe” may include visual or other observations, such as audio, device interaction, touchpad interaction, and food consumption, among others. In one implementation, the response is in real time or is sufficiently rapid as to appear to be a real time response. In another implementation, the response time is sufficiently rapid that the animal is capable of associating the response with the movement. The response may be made to animal position (location within the space), posture (position of one or more of its body parts relative to the floor and/or other environmental element, or a combination thereof). Note that the system may take advantage of the patterns that control and/or coordinate muscle action. In one respect, coordinated behaviors may be thought of as similar to eigenvectors (over terms that may at base be nonlinear), in that one or more simple neural activations could control a more complex behavior. The stimulus presented to the animal may, in one aspect, correlate to one or more neural activations within the dog that control and/or coordinate muscle action. In one aspect, neural activations are directly or indirectly measured.

Thus, the real-time, near-real-time (or otherwise timely) signal feedback provided by the system may infer the high-level correspondence of a simple neural activation to a more complex muscle pattern, and provide feedback based on the assumed mapping from a conjunction of readings of the positions of the animal's various parts. By way of comparison, on a steam locomotive, its movement down a single track causes a range of complex motions elsewhere. In the same way, a complex motor program (such as the pattern of walking) can be controlled by a simple higher level neural activation that modulates, e.g., the speed and quietness of the individual's foot falls.

In another aspect, EEG readings, electromyogram readings, forward looking infrared readings, or a combination thereof may be utilized to identify movement or posture or likely movement or posture.

The real-time feedback signal, if well-paired to a real-time (or near-real-time) neural signal triggering muscle response, or neural activation can be used by the animal to guide that particular neural activity to a desired outcome.

In one implementation, the various dimensions of a sitting behavior can be projected to a 1-dimensional signal, such that the standing state causes the training system to produce one “default” tone, and as the animal's posture more closely approximates that of the desired state, the tone changes gradually to the “target” tone.

Thus, the system interprets a range of sensors and projects their combined inputs onto a single parameter that is modulated in real-time. It emits this parameter modulation (e.g., falling or rising tone), and when it at least roughly corresponds to an animal's neural activation state (or potential neural activation state) it provides the animal with a way of controlling said modulation and thus obtain a reward. In this way, the system's processing of the animal's state, and subsequent feedback, provides a powerful training signal.

In one implementation, the system at first accommodates very loose parameters (e.g., if teaching the animal to sit, any movement along the interpreted “sit” trajectory qualifies for a reward). Over time, as the animal gets better, the guidelines become increasingly stringent. Assuming a real-time “scoring” of the animal's posture of between 0 and 100, if the posture at first started at zero, the animal would be first rewarded for getting to 1, then for getting to 2, and so on. In one aspect, a pending reward indication, such as a tone or light, is emitted to indicate to the animal that it is moving along the path to the desired behavior. In another aspect, the pending reward indication may vary in volume, intensity, tone, color temperature, or other aspects as the animal moves along the path to a reward.

In some behavioral applications, an inconsistent reward system (which may also take the form of “intermittent reinforcement” or “intermittent variable rewards”, which are both incorporated in this document into the term “inconsistent reward system”) is effective to alter animal behavior (indeed, an inconsistent reward system is often as effective or more effective than a consistent reward system).

Because the CLEVERPET® Hub or similar devices may be utilized as both a training device and a food-dispensing device, it may be desirable to stretch the food rewards over a longer period of time. For example, if an owner leaves enough kibble to dispense 50 food rewards and the owner is gone for the day, it may be desirable to engage the animal in more than 50 training episodes. Similarly, the dog's permitted caloric intake may limit the amount of food that may be dispensed. In such cases, each training episode may have a random (or, if not random, apparently random from the animal's perspective) chance of providing a reward. In one aspect, a sound or other signal is made substantially concurrently, or temporally before, as a predictor, with the dispensing of a food reward, so that the animal knows it has achieved the goal whether or not a food reward is dispensed. That is, a secondary reinforcement may be employed that increases the likelihood of desired future behavior without needing to use the primary unconditioned reinforcer (food). Similarly, it may be desirable to dispense a food reward all or nearly all of the time at the outset of training and/or a training session, and reduce the likelihood of dispensing a food reward as the training progresses. Returning to the example, the first 10 rewards (of the 50 loaded in the device) may be rewarded the first 10 times the animal complies with a training effort (preferably, for all 50 rewards and/or all other times the animal engages in behavior that triggers a possible reward, in association with a reward sound or signal), then the next 10 rewards deployed 50% of the time, then the next 30 rewards deployed 30% of the time. In this way, the 50 food rewards enable approximately 130 training episodes.

It should be noted that the stimuli described herein, and in the examples and discussion below, may be emulated by a portable device, such that an animal may be made to engage in the behavior taught by the CLEVERPET® Hub or similar device, even outside of the range of the CLEVERPET® Hub. For example, a user may utilize an iPhone to generate a tone or other signal associated with “stay”. In another aspect, the mobile device may have an adjustable mechanism, such as a slider, that allows the human user to move the tone from the “approaching the behavior” tone or signal to the terminal “achieved the behavior” tone or signal. In another aspect, the sensors on the mobile device may be utilized, alone or in conjunction with other sensors or manual input, to control the stimuli.

These inventions may be utilized, among other things, to teach an animal to:

Move to a Particular Place in an Environment:

It is often desirable to move the animal within an environment. For example, if a “Roomba” is set to clean a room, it is desirable to have the animal leave the room. The CLEVERPET® Hub (or analogous device) guides the animal, in one implementation by mapping the nose of the animal to a desired location in space, and allowing the animal's exploration to modulate the parameter as appropriate. In one aspect, this may be similar to the game “hotter/colder”, using light, sound tone, sound modulation, sound volume, light intensity, light frequency, and/or scent in place of the words “hotter” and “colder”. Alternatively, or in addition, words may be utilized such as “hotter” and “colder”.

Teach the Identity of Objects:

A sound, light, other signal or word is associated with an object (for example, a sound may be associated with “ball”). The Hub plays the sound “ball”, and then guides the animal over to the target ball (using the guiding technique outlined above and/or other inventions disclosed herein). Over time, the animal needs to reach the ball more and more quickly in order to get a food reward. In another aspect, the difficulty can be increased by increasing the number of candidate objects. The difficulty can be further increased by requiring the animal to deposit the acquired object in a given location. This can work for teaching the names of toys, tools, pieces of furniture, rooms in the home, or the identities of persons or other animals.

Teach Sit, Down, or Other Postures:

The CLEVERPET® Hub or similar device may provide feedback and/or rewards as the animal achieves progressively closer motions toward the desired posture. The posture may be associated with a word and/or other stimuli.

Teach Stay or Stop:

The CLEVERPET® Hub or similar device may teach a pet to stay and/or stop motion in a variety of ways, including the various inventions described above. In one aspect, the device play a tone that is close to the target tone, and have it gradually increase as the animal motion reduces until it reaches the target tone. If the animal moves, the tone may be reset.

Train Inhibitory Control:

The inventions may be utilized to train inhibitory control. For example, one may be to cause particular actions (e.g. lifting of a paw) and then once the action is half-performed, the animal is provided an indication that the action should remain half-performed for increasingly longer periods of time. The animal is thus inhibiting the performance of an action. By varying the actions, more general inhibitory control can be cultivated. In the context of touch pads, the animal can be required to hold his paw (or nose) on a touch pad for a longer and longer period of time in order to eventually get the reward.

Teach Color Difference:

The CLEVERPET® Hub, first generation, has three touch pads. Other similar devices, and future iterations of the CLEVERPET® Hub may have more or fewer touchpads, display screens, flexible displays, projected displays, or other input and/or output devices. Color difference may be taught by rewarding the animal for touching the “one that's not like the others”. This can also be done with a computer vision-based system and/or a light projection system, with or without incorporation of touchpads.

Potty Training:

A computer vision system may detect when dogs are about to “pop a squat” and interrupt. For example, the system may emit a sound every time dog is urinating/defecating, and use this sound to cue the behavior later on. Similarly, there may be a sound or other stimulus (“failure stimulus”) that indicates that the animal has failed to earn a reward, such as a “bleep” sound that indicates the animal has failed at a “remember the pads that lit up in order” game. When the animal is urinating or defecating at an inappropriate place or time, the failure stimulus may be provided, and optionally rewards terminated for a period of time. Another aspect of this invention may be utilized to train a cat or other animal to move toward and utilize a toilet or other appropriate receptacle for urinating or defecating.

Exercise:

Reward for running from one location to another in the home.

Agility:

Reward dog for performing agility behaviors (pole weave, teeter-totter, etc.)

Prevent Dog from Interacting with and/or Damaging Furniture:

A computer vision system or other sensors may detect that the dog is on furniture. The system may provide feedback that it is the wrong thing to do (for example, aversive feedback, “stonewalling”/removing stimulation, or a failure stimulus).

Improve Dog's Mood:

If the system detects that the tail is not wagging, the animal may be rewarded for wagging the tail. There is significant evidence that engaging in behavior associated with a happy feeling may trigger the happy feeling. System may alternatively present a range of stimuli or interactions and observe consequent tail wagging behavior. This may inform which stimuli the system chooses to present, as well as informing modulation of the presented stimuli with the goal of maximizing frequency and duration of tail wagging behavior.

Teach Dog to Attend to Video Display:

A computer vision or other system may detect and reward an animal for positioning the head such that animal is looking at display. There may then be visual stimuli on display predictive of dog behaviors that lead to a reward. E.g., arrow right (or image of person pointing right): if dog moves right, dog gets treat. Similarly, arrow left: if dog moves left, dog gets food.

Other Things that can be Taught:
Dog controls household lights
Dog does a backflip
Dog stays away from cat, and vice versa
Dog learns more complex commands (check and close all the doors in the house/perimeter sweep, open the door for a visitor, Dog ignores letter carrier etc.)
Language

Teach Dogs to Take Action
Dog needs to perform a different action: For example, nose or pick-up or paw or toss.
Taught by naming action and rewarding dog for the performance of the action

Teach Dogs to Take Action Vis-à-Vis a Person, Place, or Thing:

as above, but with nouns involved. In one aspect, the animal may be proximal.

Imitative Behavior:

A video display of another animal performing an action, optionally in conjunction with additional stimuli, may be utilized to assist the animal in determining the desired action. This may be employed after the animal was taught to attend to the video display. Observation of the animal and reaction via the video display may be used in order to increase the amount of, as well as make more precise, the animal's attention to the video display.

Touch Screen

Certain of the inventions described in U.S. patent application Ser. No. 14/771,995 as well as herein may be implemented utilizing a touch screen. In one aspect, the touch screen is proximate to, or integral with, the CLEVERPET® Hub or similar device. The touch screen may initially be configured to imitate the appearance of an earlier generation of the CLEVERPET® Hub or similar device.

The screen need not literally be a touch-sensitive screen, as interaction with the screen may also be measured utilizing other mechanisms, such as video analysis, A Kinect-like system, a finger (or paw, or nose) tracking system, or other alternatives.

In another aspect, a flexible display may be operably attached to a CLEVERPET® Hub or similar device and used to cover some or all of the surface of that device. In another aspect, the color palette (either capability of generating the color and/or the color programmatically called for) for the touch screen is modified to maximize the ability of the dog to see the images.

The touch screen may utilize resistive technology, surface acoustic wave, capacitive touch, an infrared grid, infrared acrylic projection, optical imaging, dispersive signal technology, acoustic pulse recognition, and/or other technologies and/or a combination thereof.

In one aspect, the use of a surface acoustic wave (“SAW”) may utilize acoustic properties that are perceptible to dogs (and optionally not to humans). In this way, the dogs receive feedback as they interact with the device from the interaction itself regardless of whether the software or other hardware characteristics of the device provide feedback. In one aspect, piezoelectric materials are utilized.

Singulation

Singulation (or to singulate) as used herein means to separate a unit (e.g., an individual piece of food or kibble) or units (e.g., a measured quantity of dog food or kibble) from a larger batch of food or kibble. In PCT/US15/47431, among other things, a spiral dispensing device is disclosed which is used to singulate items (e.g. food, kibble, treats, candy, etc.). In particular, in paragraph 12, a frustoconical housing adapted for rotation is disclosed, as well as “housing [that] features a novel spiral race extending from a first side edge engaged with the interior surface of the sidewall of an interior cavity of the housing, defined by the sidewall. The race extends to a distal edge a distance away from the engagement with the sidewall of the housing. So engaged, the race follows a spiral pathway within the interior cavity from the widest portion of the frustoconical housing, to an aperture located at the opposite and narrower end of the housing” to singulate items located within the housing.

In one aspect, a CLEVERPET® Hub or similar device is operably connected to and/or integrates the singulation system (while we utilize the term “CLEVERPET® Hub” herein, it should be understood to include other devices with similar functionality, to the extent that such devices exist or will exist).

An embodiment of a spiral dispensing device (i.e., a frustoconical housing) is shown in FIGS. 11, 12A-12B. In FIG. 11, CLEVERPET® Hub 1101 is shown in therein with its cover removed, thus exposing the spiral dispensing device 1114. A similar spiral dispensing device 1214 is shown in FIGS. 12A-12B. In the cross-sectional view of FIG. 12B, taken along line B-B of FIG. 12A, the spiral race 1224 inside of the device 1214 may be seen.

A further novel element is a removable spiral race that may be exchanged for a different race. In addition, variations may include a race that rotates around the interior a greater or lesser number of times over the same distance or a race that extends greater or lesser distance from the interior of the housing to the center of the housing.

A further novel element includes variations to the surfaces within the housing and/or the surfaces of the race. In one aspect, a surface covered with bumps is disclosed. The bumps may be raised or indented, and may be small enough to be invisible to the eye, so large that only one bump exists in every twist of the race, or any size in between. It is desirable that the interior of the housing be easily amenable to cleaning. In one aspect, the interior surfaces may alternate between smooth and less smooth materials, and/or between harder and softer materials, but without sharp angles that can catch food or materials. In one aspect, an angle of greater than 110 degrees or utilized. In another aspect, no angle (between the bump and the surface) is less than 150 degrees.

In another aspect, the race is affixed to the interior surface of the housing utilizing a graduated connecting angle greater than 90 degrees.

It is also desirable that the aperture be capable of changing size, whether by manual adjustment, mechanized adjustment, or a combination. Similarly, the housing itself and/or the race may be flexible capable of lengthening or shortening, changing the size of particle that is best conveyed by the device (note that the term “particle” is utilized herein to reference an item being dispensed, which item may include kibble, unwrapped food, wrapped food such as Hershey's Kisses, or other items that are desired to be dispensed).

In one aspect, a database of particle sizes may be accessed by the device based on manual entry of the item being dispensed, OCR, QR code and/or bar code reading of the item being dispensed, or spectrographic analysis of the item being dispensed. The size range of the particles is then loaded from the database. Alternatively, or in addition, the system may measure the size range of the particles utilizing computer vision.

In another aspect, the aperture starts out closed, and gradually opens until particles begin to be dispensed. Such dispensing may be measured in a variety of ways, including (i) measuring changes to the weight of the housing and contents; (ii) measuring changes to the weight of a dispensing tray; (iii) measuring reflectivity of a dispensing tray; (iv) measuring interruptions or changes to a light beam, such as by a combination of a laser and a light detector deployed outside of the aperture; (v) measuring sounds and/or changes to sounds generated by the dispensing system; (vi) measuring the sound of a particle hitting a dispensing tray; or (vii) via other methods, as described in the '431 application. In one aspect, the aperture may be opened by a fixed amount or percentage greater than the opening size at which a particle passed through. In one implementation, the aperture should be increased by less than double the size of the aperture at which at least one particle passed through. In one aspect, the initial size, and/or any increase in size is reflective of the data from the database of particle sizes.

In another aspect, once particles stop being dispensed, the size of the aperture may be increased until particles are again dispensed. In another aspect, if multiple particles are dispensed (as measured, for example, by multiple interruptions to a light beam or multiple sounds of particles hitting a dispensing tray), the aperture may be reduced in size. In another aspect, once particles stop being dispensed, the size of the aperture may be increased and decreased by a slight amount repeatedly in order to dislodge stuck particles and/or cause new particles to pass through the aperture. This size change may be done independently, in conjunction with rotation of the body, in conjunction with rotation of the race, or a combination. It should be noted that in one implementation, the race is capable of moving independently of the body.

The aperture size may be adjusted, and/or the sizing process restarted, after (i) opening of the device to add or change contents; (ii) a set period of time; (iii) a set number of dispensing events; (iv) a set number or percentage of failed dispensing events; (v) after a set period of inactivity; and/or (vi) after environmental changes, such as temperature changes or humidity changes.

It is desirable that the race be removable, whether for cleaning or for changing the functionality of the device (for example, by introducing a race more suited to particles of a different size range). In one aspect, the body may be latched and hinged so that it may be opened, the race removed, and a new race inserted. In another aspect, the body may be surrounded by an array of pins. The pins may be pushed flush with holes in the sidewall of the housing or may be pushed through holes in the sidewall of the housing, in order to create a race of a different size and/or pitch and/or depth. In one aspect, the holes through which the pins pass (or sit flush against) are surrounded by or adjacent to an inflatable, deformable, and/or magnetic feature that is capable of holding each pin in place. For example, the interior wall of the housing may be made from a flexible material. The housing is rotated and as the pins reach a point in the rotation where a motor may be utilized to move them or, in a different implementation, gravity utilized by waiting until the pins reach the bottom (for pins to be retracted) or the top (for pins to be extended), a section of the sidewall (in one aspect, the sidewall may be composed of many different sections, each capable of being stretched individually) is stretched to allow the pins to move or compressed to prevent the pins from moving.

In another aspect, a series of electromagnets may be deployed along the top of the housing. As the pins reach the top of the housing, each electromagnet is operably assigned to the control of one or more pins. For pins that are to be retracted, the electromagnet is activated. For pins that are to be deployed, the electromagnet is not activated. In one implementation, the movement of the pins through the holes is facilitated by stretching the material of the housing to increase the size of the holes at the point in rotation where the electromagnets are utilized. In another aspect, fixed magnets may be utilized, in one implementation rare earth magnets, which are then retracted away from the pins or extended toward the pins in order to cause some pins to deploy through the housing and others to remain flush with the housing.

It should be noted that the pins need not literally be pins, but may also be shaped and/or coated as desired to enhance function, such as by utilizing a smooth coating to prevent damage to the particles by the pins.

In this way, the race may be changed in real time without accessing the interior of the device.

In another aspect, the movement of particles along the race may be enhanced, impaired, or otherwise altered by the movement of air through the device. For example, a fan situated at the posterior of the device may enhance the speed and/or efficacy of movement of particles toward the aperture.

In one aspect, the race may be composed of a thermally responsive material that shrinks substantially when below a certain temperature. In this way, the race may be removed through a smaller aperture when the race is below that certain temperature, and a similarly chilled replacement race may be inserted. As the race temperature increases to ambient temperature, it increases in size to properly fit the housing.

In another aspect, the race may be made with a flexible housing that is capable of being filled with a liquid or gas. When it is desirable that the race be removed, the liquid or gas is removed or reduced and the race becomes flexible and amenable to removal. Similarly, a new race may be inserted and then expanded to a more rigid state by filling it with the liquid or gas.

In another aspect, the efficacy of the race may be varied by inflating and/or deflating a device, such as a rubber ball, in such a manner that it fills some or all of the interior of the dispensing device without blocking (or at least without fully blocking) the channels in the race.

A problem for certain types of materials, such as chocolate, is that the materials may change consistency as temperature, humidity, or other conditions change. For example, a machine dispensing Hershey's Kisses may function well at room temperature, but may become less functional, non-functional, or even temporarily or permanently disabled if it is exposed to temperatures hot enough to render the chocolate soft or even liquid.

To prevent this problem, one aspect of the inventions monitors the temperature inside and/or outside of the device, and once a threshold temperature is reached, takes action. In one aspect, the action is to reverse the direction of the race to remove as much of the contents of the race as possible. Another action may be to dispense all of the product through the aperture, or to actuate a diversion device (such as a valve) to redirect the particles coming through the aperture into a storage area. In one aspect, the storage area may be connected to the distal end of the race so that once the temperature is acceptable, the race may dispense those particles. Another action may be to sound an audible or visible alert. Another action may be to seal the aperture in order to prevent the flow of hot (or cold) air into the device. Another action may be to send an alert signal, whether audible, visual, electromagnetic, WiFi, cellular, or otherwise. Another action may be to inflate a device (such as the rubber ball described above) within the race in order to hold the particles in place until the temperature within the race (and/or outside of the race) reaches a certain level.

While the foregoing discussion was in the context of temperature, it should be understood that the same or similar actions may be taken in response to humidity or other environmental changes.

In another aspect, a thermostat may be utilized to control a cooling device operably connected to the dispenser and/or race.

The capacity of the device may be increased by storing contents in an unwrapped, melted, liquid, or other form. Taking as an example Hershey's Kisses, the shape is such that a substantial amount of air space will exist within a storage area filled with particles. In one aspect, the chocolate may be stored in liquid form and shaped and cooled prior to being released into the hopper or storage area that feeds the race. In another aspect, particles may be wrapped prior to entering the race. For example, a device may dispense toys, such as dice. Because the consumer desires the toy to be dispensed in a container, the conflict between the loss of capacity associated with storing the dice within individual containers and the consumer desire to have a container is resolved by putting the toy into the container before entering the race. While it is thought to be preferable to affix the container prior to entering the race, changes to packaging or form of the contents may be done after exiting the aperture at the end of the race.

Certain foods or other contents may be prone to become stuck to the inside of the race, aperture, or other portions of the device. Similarly, certain foods, such as kibble, may be preferably softened prior to serving. In one aspect, the interior walls of the container and race may be coated with liquid in order to prevent sticking and/or to soften the contents prior to serving. In another aspect, the interior walls may be kept below freezing or at another temperature in order to minimize adhesion to the walls. In order to prevent the dispensed contents from freezing, there may be a heating element in the center of the device, at or near the aperture, or otherwise. The heating element may be resistance heating, a Peltier device, a laser, or other heating modality.

In another aspect, the interior of the device may be periodically coated with a substance, such as oil or flour, that may acceptably come into contact with the particles without making them unusable for their desired use.

In another aspect, the coating may be varied (with or without regard to the anti-adhesion characteristics) in order to change the taste and/or smell and/or color and/or appearance of the particles. For example, damp dog kibble may be dispensed and the interior coating initially flavored with lamb, then with chicken, then with beef, in order to improve the experience for the animal.

In another aspect, there may be a spray device affixed at or near the aperture. The spray device may be utilized to change the liquid content of the particles and/or to flavor or scent or color the particles.

It may be desirable to intermix particles. For example, if a human wants to have a mix of ⅔ kibble and ⅓ dog treats within the device, it is desirable that the human be able to fill the device and have the device mix the particles. In such a case, the race may be rotated in a forward direction for a certain period of time, and then in a reverse direction, in order to intermix and then return the particles to the storage area.

In another aspect, it may be desirable to have a certain mix of particle sizes and/or particle types within any given dispensing event. For example, it may be desirable to dispense a single Hershey's Kiss together with a single candy heart. To accomplish this, a plurality of frustoconical housing/race combinations may be utilized. They may all be operably connected to the same dispensing tray or dispensing location, or may be dispensed in separate places (with or without a tray). In another aspect, two or more races and housings may be utilized where particles smaller than a certain aperture size fall through the aperture into a lower housing (and the process optionally repeated for additional housings), thus accomplishing the task of separating differently sized particles automatically.

If the race height “L” is small enough, a certain percentage of objects will tumble backward down the housing as their centers of gravity reside above “L” and they are no longer supported by the race. This is a key feature of a mechanism that supports singulation; as objects progress along the race in the direction of the longitudinal axis, they lift up the sidewall and end up perched atop the particle that had just been below them along the race. Since they are now perched atop a second object, they are more likely to be above the race height “L” and often fall backward, leading to only the piece that had been below continuing up along the race. In this way, groups of objects that might otherwise have been dispensed together are separated and singulated.

Animal Noise

Preventing a dog from barking is generally achieved by behavioral training from an expert trainer. In some cases, mechanical devices, such as ultrasonic speakers, or anti-bark collars, serve by pairing an aversive stimulus with barking. Among other embodiments disclosed herein, we present a novel system, method and apparatus, which prevents intrinsically non-aversive stimuli, indicating to the dog the future consequences of barking. One novel aspect disclosed is automatically teaching a dog the meaning of auditory stimuli by consistently pairing them with future consequences.

Additionally, the future consequences need not be aversive themselves. In one embodiment, a future reward is removed. In another embodiment, the work required to earn a future reward is increased. In another embodiment, a future reward is guaranteed upon fulfillment of sustained non-barking. In certain embodiments, the presence of future conditional rewards is communicated to the dog in a salient understandable, but non-aversive message. In certain other embodiments, there may be negative reinforcement, whether in conjunction with the foregoing rewards and/or communication system or otherwise.

It should further be understood that there are different levels of barking. For example, a dog may make a single, short and quiet “yip”; may make a plurality of long and loud barks, or anything in between. Indeed, growling can (and for the purposes of this disclosure, may, where appropriate) be considered a form of barking (although the training parameters for growling may be different than those for barking). In another aspect, howling may be considered a form of barking for purposes of triggering rewards, incentives or other aspects of training. The rewards, incentives and other aspects of training may be varied based on the nature of the sound. For example, a short yip surrounded by N seconds of silence may be treated as the same as the absence of any barking. In one aspect, N may be 1, 5, 10, 15, 20, 25, 30, 35, 40, 45, 50, 55, or 60 seconds, or any number of seconds between 1 and 600. N may be capable of being set by the operator of the system, may be determined and/or modified algorithmically, may be set based on the breed and/or size and/or age of the dog, or otherwise.

Many pet owners would like to train their dogs. They may not have the financial means or motivation to hire a professional trainer, nor the expertise and free time to perform the training themselves. Such pet owners may be uncomfortable providing noxious, aversive or painful stimuli to punish their pet dog. Additionally, such stimuli may serve to aggravate the dog, and may not reduce overall problematic behavior. It should be further noted that certain dogs suffer from post-traumatic stress, such as dogs that have been abused, abandoned, attacked, or otherwise traumatized. For such animals, aversive stimuli may trigger undesirable responses, ranging from biting and barking to fearful urination.

The systems described herein have the capacity to offer expertise in behavioral training by using cheap low cost sensors coupled with an animal reward system.

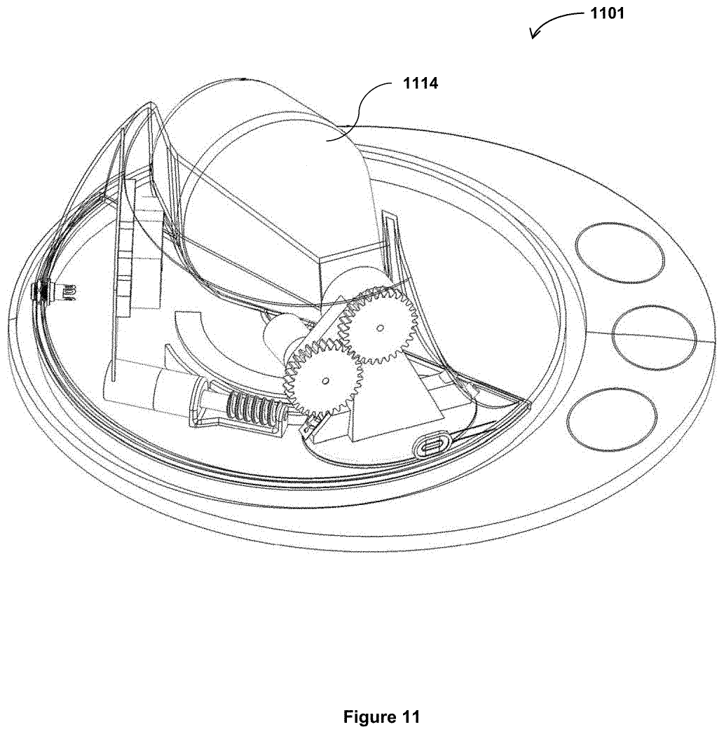

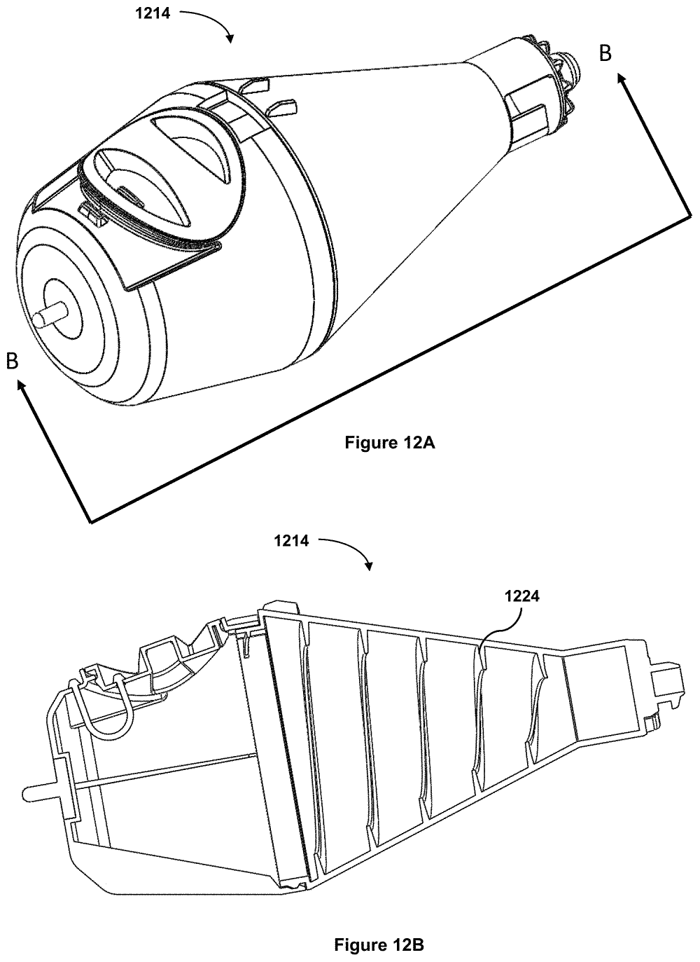

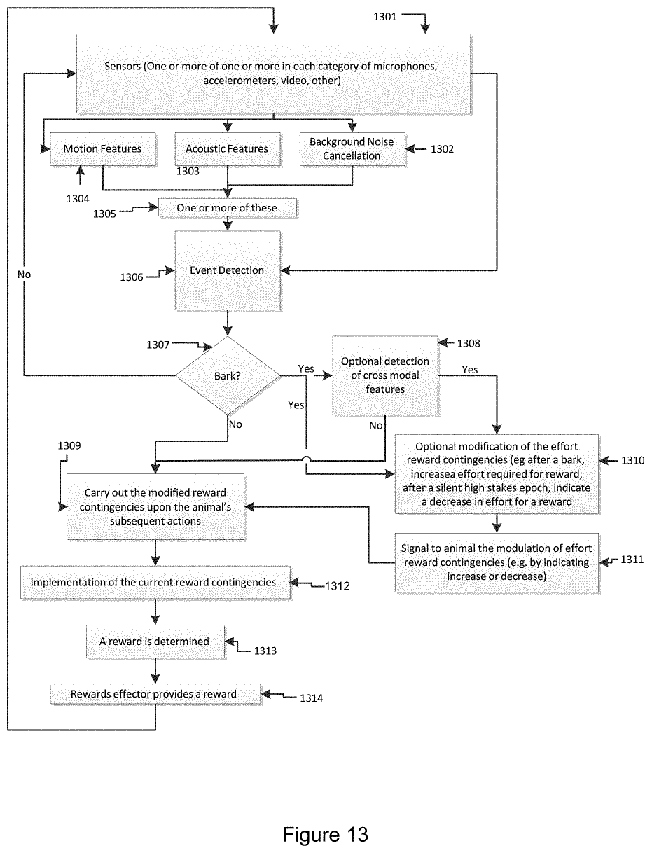

Referring now to FIG. 13, a method of behavioral training is shown. Specifically, FIG. 13 illustrates a method of preventing a dog from barking by administering rewards, when appropriate. At step 1301, one or more sensors proximal to the dog detect the presence of a bark originating from the dog. The sensors may be one or more microphones, accelerometers, one or more inertial measurement units (IMU) proximal to the dog (such as on the dog's collar), vibration sensors and/or other type of sensor that may be used to detect barking. In one aspect, a microphone and IMU are combined to detect a bark in the vicinity of the microphone. In another aspect, video monitoring of motion by the dog's mouth may be utilized to detect or gauge the likelihood that a particular dog was the source of a particular sound.

At step 1302, background noise cancellation may be performed on the sensory data, and events logged for subsequent computation on candidate bark events. At steps 1303 and 1304 a sound event classification algorithm may be performed and include acoustic features 1303 from a primary modality (e.g. just the speaker bark feature threshold) or also features from other modalities, such as motion features 1304. In one aspect accelerometer event data from the collar on a dog may be used, allowing sounds to be better classified. In any case, at step 1305, one or more of background noise cancellation 1302, acoustic features 1303 and motion features 1304 may be combined, and at step 1306, a sound event may be detected. After sound detection, at step 1307, it is determined whether the sound event detected may be classified with sufficient reliability as being a bark. For example, a sound detected may potentially be classified as a bark, only if having arisen from a particular dog (e.g. not the neighbor's dog), and potentially, only if having arisen from particular mood state (e.g. not including happy dog grunts). In some embodiments, a sound event detected is only finally classified as a bark if, at optional step 1308, there is detection of cross modal features that confirm that the sound event is, indeed, a bark.

In some aspects, a future consequence is affected by changing the rules (or the parameters) or a reward system. In one embodiment, the rules map the effort a dog must exert to the magnitude of reward received by the dog. In some cases, the work may be the physical exertion required to touch a sequence of touchpads, and the magnitude of the reward may be the amount of food provided, for completing the action. In another embodiment, the work may be the mental effort required to solve a puzzle, and the reward “magnitude” may be related to the likelihood of getting a small food reward. In another system, the work may be the required actions (e.g. jumping) that increase the magnitude of sensor measurement (e.g. an estimate of the height of a jump). Thus, on average, it is possible to describe the expected reward for a given action, and it is possible for an animal to learn this relationship. This relationship may be described by a function—as a map of the contingencies between effort and reward—and is referred to herein as the effort-reward contingencies, or sometimes just reward contingencies, implying that the rewards are contingent on the relevant actions which require effort.

Referring again to FIG. 13, in some embodiments of the method for training a dog not to bark, at steps 1310 and 1311, the effort-reward contingencies may be modified and a signal may be sent to the animal of the modulation of the effort-reward contingencies. For example, after a bark, an increase in effort may be required for the animal to receive a reward, or after a silent high stakes epoch (further described below), a decrease in effort may be required for the animal to receive a reward. In any case, a signal is sent to the animal indicating the increase or decrease in effort required, and at step 1309, the modified effort-reward contingencies are carried out upon the animal's subsequent actions.

If, however, there is no sound detection event, or if the sound detected is not classified as a bark, at step 1312, the current reward contingencies may be carried out. If reward contingencies are to be carried out, at step 1313, a reward is determined, and at step 1314, the reward is provided. Where optional detection of cross-modal features (step 1308) and optional modification of effort-reward contingencies with signals of the modification (steps 1310 and 1311) are not performed, step 1312 of the method (implementation of the current reward contingencies) may directly follow step 1307 (the determination that the sound event is not a bark). However, rewards may not be provided for every instance or time period of no barking. In some cases, rewards for the animal not barking may only be provided after a predetermined period of time, potentially as set by the owner of the animal, or after an instance in which the animal would be tempted to bark (e.g., after encountering the household cat) without barking.

Training

The systems, apparatuses and methods described herein 1) train animals to learn that sensory messages indicate changes in reward contingencies, and/or 2) train animals to prevent an action by learning that the action affects future reward contingencies undesirably. Let us consider an example in an embodiment, where a dog learns not to bark. The system would train the dog to 1) learn that a 300 Hz tone means future rewards require more work, and a 500 Hz tone means future rewards will require less work, and 2) train the dog not to bark by pairing the 300 Hz tone after barking, and presenting the 500 Hz tone after epochs of time when the dog may have been tempted to bark and did not. It should be understood that any tone audible to the dog may be utilized in place of the 300 Hz and 500 Hz tones used in the example.

Additional cues may facilitate the later scenario, by calling out in advance, a candidate reward epoch has approached. For example, the presence of a mailman (that in one aspect may be detected by use of video analysis) may trigger a candidate time period with a high probability of barking. This “high stakes epoch” may contain a unique auditory signal (e.g. a clicking) indicating an eminent reward, contingent on the dog behaving properly and/or not misbehaving. It helps animals learn if they can understand that they would have gotten a reward had they not barked, and that, in the case of having barked, they understand that they had in fact lost something, even though it never happened. In some embodiments, evidence of previous barking can be used to predict future scenarios with a high probability of barking, thus detecting “high stakes epochs” much like an expert trainer would. Examples of this are the arrival of strangers at a front door via a security camera, or particular motions detected in accelerometer indicating jumping behavior or anxiety.

In some embodiments, the indication of the changes in reward contingencies may be sensed by dogs and the indication may be imperceptible to people. For example, by using an acoustic signal beyond the range sensed by people.

In some embodiments, the indication of the changes in reward contingencies are co-localized with the location of the reward effector. For example, via a speaker that is located next to an action-dependent source of food.

Measurement of Barking

Barking may be measured utilizing a variety of mechanisms. In one aspect, a detection system such as that present in Zacro Dog No Bark Collar may be coupled with a transmission mechanism (such as Wi-Fi or Bluetooth) and data about barking sent to the CLEVERPET® Hub. In addition, or in the alternative, an IMU may be utilized.

In another aspect, a one or more microphones may be utilized to detect barks. In one aspect, the microphone or microphones may be located in or on, and/or operably connected to the CLEVERPET® Hub. In another aspect, the sound may be filtered and/or required to meet a threshold to detect barks and/or to differentiate barking from other noises.

In another aspect, a plurality of microphones may be utilized to triangulate the location of the barking. Sounds from known sound sources, such as a television, may be eliminated in this way. Similarly, one or more video capture devices may be utilized to identify the location of one or more dogs, and movement of the dog's jaw or mouth may be correlated with a barking sound in order to identify the source of the barking.

Ambient sounds or noises, or video events, may be detected and utilized in conjunction with bark detection. For example, the ambient noise of a doorbell ringing may be set to correlate with a permitted barking period. Similarly, a video detection of somebody approaching the front stoop of a house may be set to correlate with a permitted barking period.

To better analyze the sounds, it may be desirable to use at least one microphone to measure the background noise, and subtract that noise from the noise detected at another microphone. Alternatively, or in addition, the background noise, having been identified, may be ignored in processing at the hub. In another aspect, the mean, modal, peak, or other measurement of ambient sound levels may be utilized to determine, in whole or in part, what level of barking noise is acceptable.

In one aspect, multiple dogs may have bark collars. One or more of the collars may be active, in the sense that it provides feedback to the dog (such as a shock) when the dog barks. The collars may be operably in communication with each other as a means to prevent the first dog's bark from triggering feedback from the second dog's collar. In one aspect, the collars compare volume and provide feedback only to the loudest dog. In another aspect, the collars compare vibration and provide feedback only to the dog with the greatest amount of vibration. In another aspect, the collars may compare data from each animal, whether vibration, sound, video, movement, location, and/or other data, and utilize that comparison to determine which, if either, dog should receive feedback.

Differentiation Between Multiple Animals and Other Matters:

There may be cases where multiple dogs are present in the same location. In such a case, the identity of the barking dog or dogs should be determined.

Ones of a plurality of animals may be differentiated in one or more of a variety of ways. When differentiated, the information specific to that dog may be loaded, either locally, from a local area network, from a wide area network, or from storage on the dog-borne device. Differentiation may be accomplished by reading signals, such as NFC or BLE signals, from a dog-borne device, face recognition, weight, eating habits and cadence, color, appearance, odor or other characteristics.

In one aspect, one or more transmitting devices may be paired with one or more receiving devices, such as a CLEVERPET® Hub. The device that is most proximate to the hub or other receiving device, as measured by geolocation such as triangulation of signals, or as measured by simple signal strength, may be utilized to infer which of the plurality of animals is utilizing the receiving device. For example, if dog A is associated with the most proximate device, the program and or data associated with dog A may be loaded into hub and/or receiving device.

In addition, animals emit different sounds. This may relate to the sound of their paws on the floor, the sound they make when they lick or chew food or drink water, the sound of their breathing, the sound of their barking, or even the sound of them rubbing these other parts of their body or of other elements in the environment. In one aspect, the sound or sounds detected by the receiving device may be utilized to identify the animal interacting with the device, whether alone or in combination with other indicia.

Furthermore, visual recognition may be utilized to identify the animal interacting with the device. It should be noted that large-scale differences, such as significant differences in size or color may be detected without utilizing a traditional high-resolution imaging device. In one aspect, reflectivity of the fur may be measured. In another aspect, the weight of the animal may be detected utilizing any weight detection device on or near the floor proximate to the hub.

Identification of Animal Position Measurement

For various reasons, it is desirable to know the physical posture of an animal at a given time. For example, a dog with difficulty remembering to urinate outside may adopt a walking posture, walk to the corner, adopt a head-up posture, squat, and then urinate. Identifying that the dog has adopted a walking posture, walked to the corner, and adopted a head-up posture, for example, provides an opportunity to intervene, train the animal, or otherwise interact with the animal using the information made possible by the animal's posture. In addition, automated training regimens may be created if it is possible to measure the animal's position.

In one aspect, pixels that change between frames may be considered as candidates for being a portion of the animal, while pixels that remain unchanged between frames may be considered as background. While these presumptions may be verified, they provide a helpful starting point in certain implementations. In another aspect, the heat measurement mechanisms described below (such as FLIR) may be utilized to determine whether the thing that is moving is related to other areas where there is movement. For example, if a dog is sleeping on the floor and then wakes up and stands up, the floor will retain the heat from the dog and then begin to cool. As the cooling trend is detected, it can be inferred that the area that has been exposed by the dog's motion is in fact background. Of course, while cooling is the most likely scenario, it is possible that the dog is cooler than the surface, in which case the surface would warm up after the dog moves. As the temperature is identified as moving toward the ambient temperature and/or the temperature of adjacent areas, it may be inferred that these areas are non-living and/or background. Similarly, temperature that differs from the ambient temperature yet remains stable or largely stable and/or that moves away from the ambient temperature, is an indicator that that area of temperature is a candidate for identification as an animal.

Dogs are furry animals, with fur arrangement and thickness that varies considerably from dog to dog, and even within the same dog as a result of grooming, making identification of their posture particularly difficult. Standard visual light spectrum imaging, including portions of the spectrum that fall outside of that which can be perceived by human vision, but within that which can be perceived by a standard CCD or CMOS imaging chip, is particularly challenging as a sensor modality for identifying animal position. In one aspect, it is desirable to utilize far infrared, or forward looking infrared (FLIR) sensing devices to better avoid fur detection issues.

One technology that may be utilized is a computer-generated combination of a visible light camera and a FLIR camera (“FLIR ONE”). Utilizing FLIR ONE, the FLIR and visual light techniques may be applied separately and/or in combination to gather data useful in determining posture.

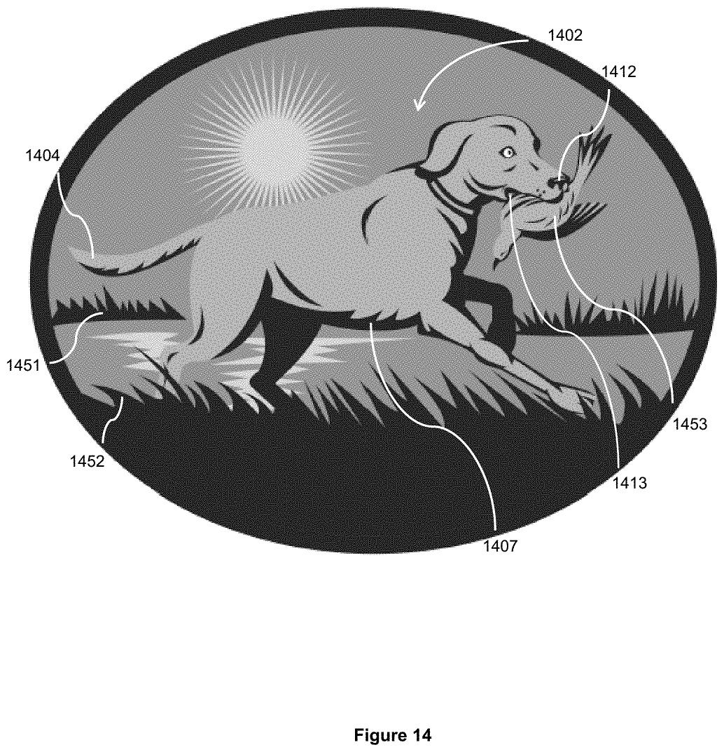

Turning to FIG. 14, we see a depiction of a dog 1402 on a grass surface 1452 with foliage 1451 in the background and a bird 1453 in the dog's mouth 1413. The dog's tail 1404 and stomach 1407 have visible fur. For further illustration, imagine that the color of the dog 1402 is straw-golden, as is the color of the grass 1452 (which has perhaps dried out) and the foliage 1451. Imagine the color of the bird 1453 is black and white, with the black matching the nose 1412 of the dog 1402.

As the dog 1402 moves across this visual field, tracking the dog's posture presents a significant problem. Differentiating the fur from the background can create the false appearance of an incorrect position. For example, if the dog were to crouch without sitting, the fur would meet the grass and prevent the imaging system from differentiating sitting from squatting or crouching.

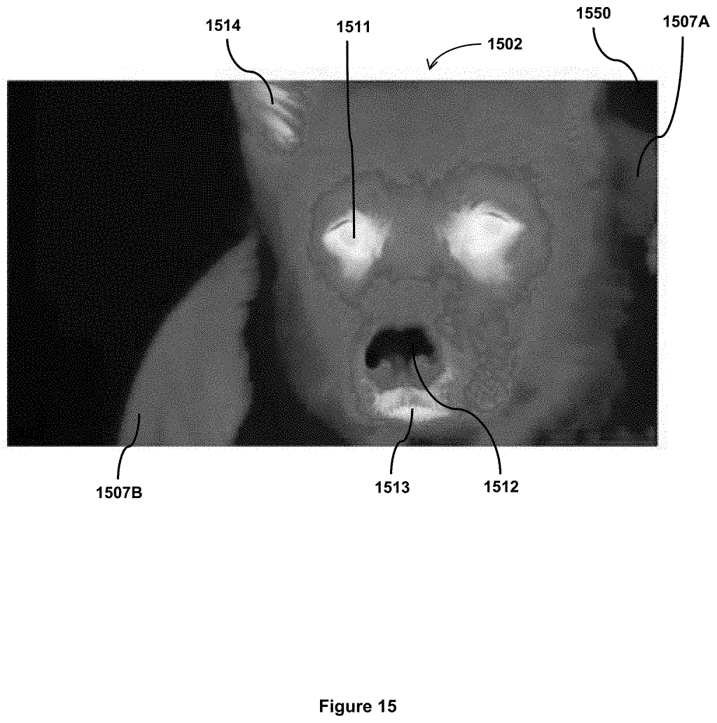

Utilizing a FLIR camera, certain features of a dog are far more easily discerned. Turning to FIG. 15, in an image captured using FLIR, we see that the nose 1512 is a different temperature than the portions of the dog that constitute dry skin, such as the lips 1513, inside of the ear 1514, and eyes 1511. Even in the areas that are less visible, such as the background 1550, the edges of the fur 1507A, 1507B can be differentiated because the fur is a different temperature.

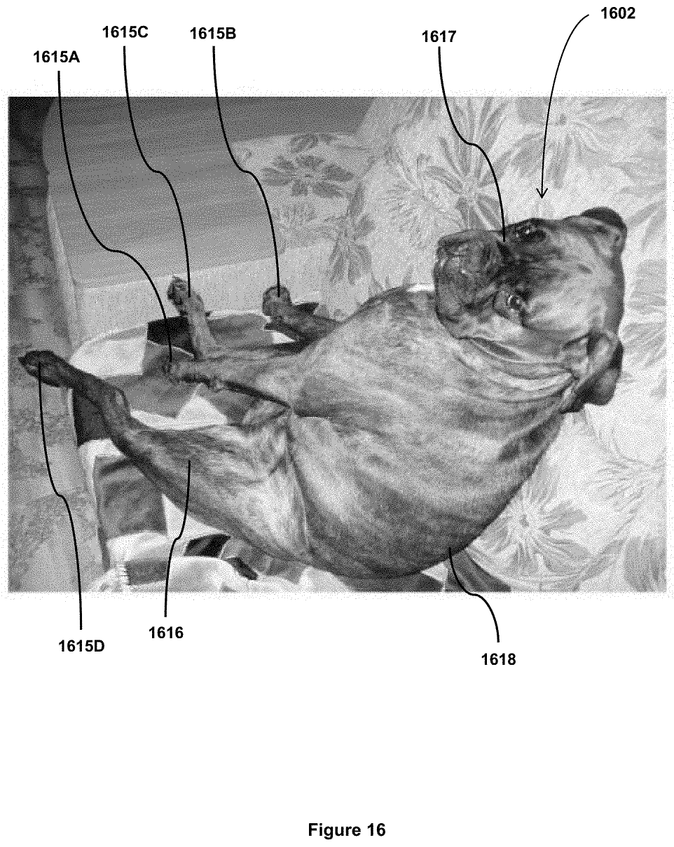

Referring now to FIG. 16, we see a visual light spectrum color photograph of a dog 1602. This illustrates a second problem with posture identification: Dog coloration is often variable across the animal's fur and can blend into the background easily. We see that the paw 1615A may fully occupy an area that is the same color. Similarly, the paw 1615C may intersect background colors that are also variable creating issues, particularly when the portion of the animal covers the transition between background colors as paw 1615C does. There may also be background shapes that appear as an extension of the paw 16156 or other animal parts. Even with an animal with very short fur, and/or a portion of an animal that has short fur, such as a dog's face 1617, background elements may create a “feathering” effect or otherwise appear like fur. Similarly, other portions of the body, such as the back 1618, may blend into the image. Finally, some body parts, such as the upper leg 1616, may extend in one direction while a similarly colored background element may extend in another direction, creating confusion as to which portion is the animal and which is the background element.

Utilizing FLIR is one way to differentiate background elements. It is possible, particularly where the dog has been in the same area as the background elements for long enough, that the temperatures of the fur and background elements will be similar, and therefore evade differentiation using FLIR. However, even in such a case certain elements of a mammal generate heat that raises (or generates perspiration or other cooling effect that lowers) the temperature of the surface, which may be fur, skin, or other elements, to a temperature different than the ambient temperature of the background elements, again permitting differentiation via FLIR. It should also be understood that there are identifiable border lines in certain areas of a dog imaged using FLIR.

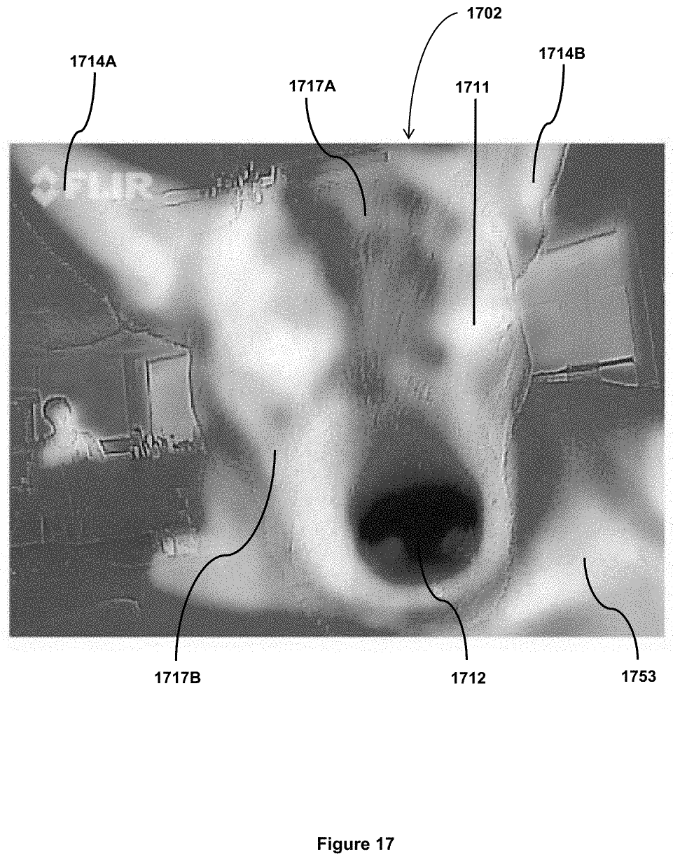

Turning to FIG. 17, we see a FLIR ONE image of a dog 1702. Portions of the dog 1702 that are not covered with fur appear “hot” such as the inner ear 1714A and the eye 1711. There are differentiating temperatures depending on fur thickness and other factors, as illustrated by comparing the central face area 1717A with other areas. It should be noted that in some cases, the ambient temperature—particularly in a place 1753 where the animal was recently sitting—may be difficult to differentiate from the animal's temperature. It should also be noted that the nose 1712 is a different temperature. Of significance is that the FLIR ONE technology creates a fairly prominent border line between certain portions of the dog 1702 and the background, as observed at the edge of the ear 1714B and the side of the face 1717B.

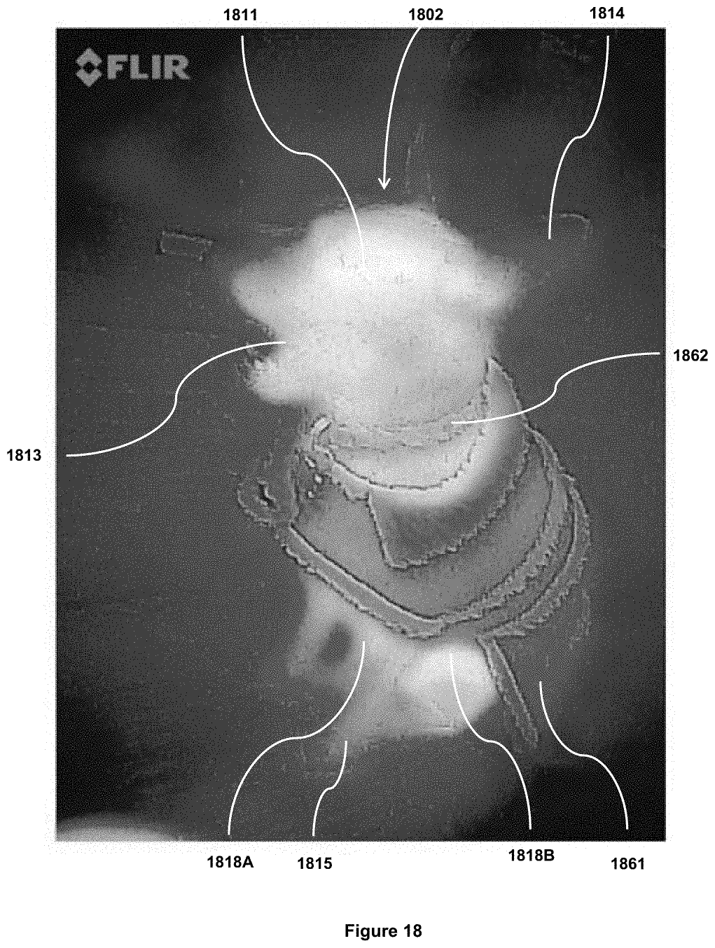

Turning to FIG. 18, we see a seated dog 1802 with an open mouth 1813 and a winter coat 1861. Because of the thin skin at the tips of this dog's ear 1814, it is difficult to differentiate the ear 1814 from the background. Similarly, while the eye 1811 is hotter than other areas, it is possible (as in this case) for the heat of the eye 1811 to be similar to that of the surrounding tissue. Further, areas of the body 1818A, 1818B that are in contact with clothing 1861 may be hotter than other areas of the animal. There are also limitations to the technology, such as the slight bleed of heat from the animal onto the sitting surface, as observed in the area between the leg 1815 and the body 1818A. Similarly, we typically see a decrease in temperature as we move from more central areas of the body 1818B to more distant areas, such as the paw 1815.

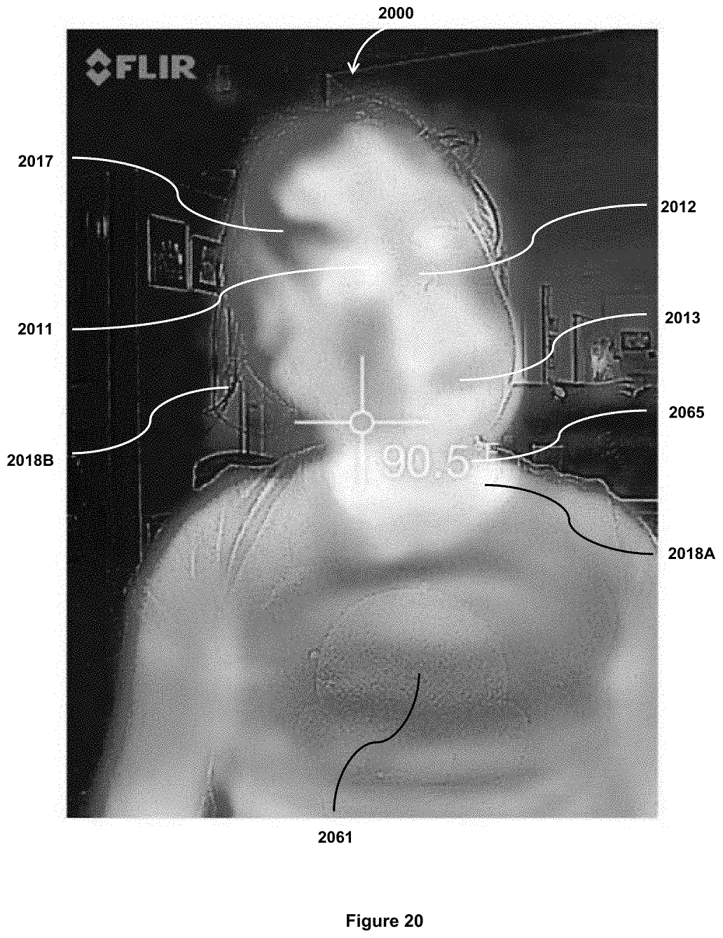

Referring to FIG. 20, we see a FLIR ONE image of a human 2000 with long hair. It should be noted that differences in clothing thickness or nature may create temperature differences. Exposed surfaces or skin 2018A, or eyes 2011, may reflect a hotter temperature than certain other areas, such as the upper chest, which may be covered with clothing 2061, or the nose 2012, which tends to be cooler. It should also be noted that FLIR is capable of precise temperature readings 2065, which may be utilized in measuring animal health and other status. The long hair may cover the face 2017, creating temperature differentials. Similarly, areas of the hair away from the body 2018B may be difficult to differentiate from the background.

It should be understood that the presence or absence of fur significantly impacts the surface temperature differentials as measured by a FLIR device. For example, the human 2000 without fur in FIG. 20 has significantly less feature distinction than those of the dog 1802 in FIG. 18. The approach taken to utilization of FLIR image analysis may initially determine the thickness, amount, and/or presence of fur and utilize that data to alter the analysis. This detection may be done by entering data manually. However, utilizing image analysis (whether of a visible light spectrum, near infrared, far infrared, other portions of the spectrum, and/or a combination thereof) will frequently provide more accurate and/or granular data useful to FLIR image analysis. For example, a dog that has recently shed a winter coat will have different amount of body heat penetration to the fur's surface when compared to before shedding. A partially shed coat may also have different characteristics. With non-furry areas, the amount of temperature penetration change over time is far less of a factor if it impacts analysis at all. In doing FLIR image analysis, it should therefore be understood that techniques useful on a human may not work on animals and/or may be less effective on animals, particularly in comparison to the inventions set forth herein.

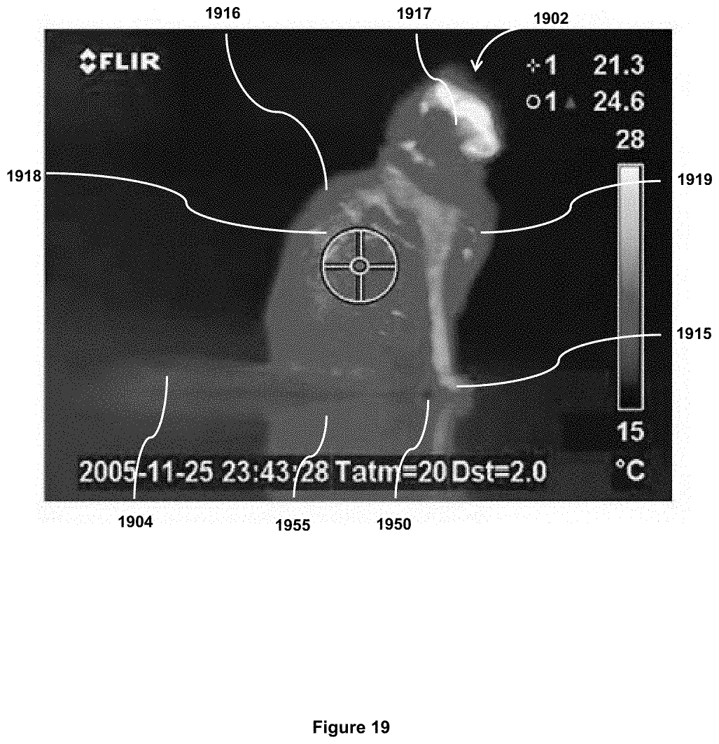

Turning to FIG. 19, we see that similar functionality is provided with FLIR ONE imaging of a cat 1902. The face 1917 is hotter than the remainder of the body. There is a line differentiating the cat 1902 from the background, as seen at points on the back 1916 and the chest 1919. As with FIG. 18, we see that distant areas of the cat 1902, such as the tail 1904, are colder than core areas of the cat 1902. The ability of FLIR ONE to differentiate the temperatures between fur and background is seen at a point of the background 1950, between the paw 1915 and the body 1918. It should be noted that a significant limitation of FLIR ONE is that the heat of the body 1918 is reflected onto surfaces, such as at point of the surface 1955 on which the cat 1902 sits, and such reflection often retains the shape of the animal. It should be understood that while much of this discussion relates to FLIR ONE, a simple FLIR device may be capable of performing the same tasks.

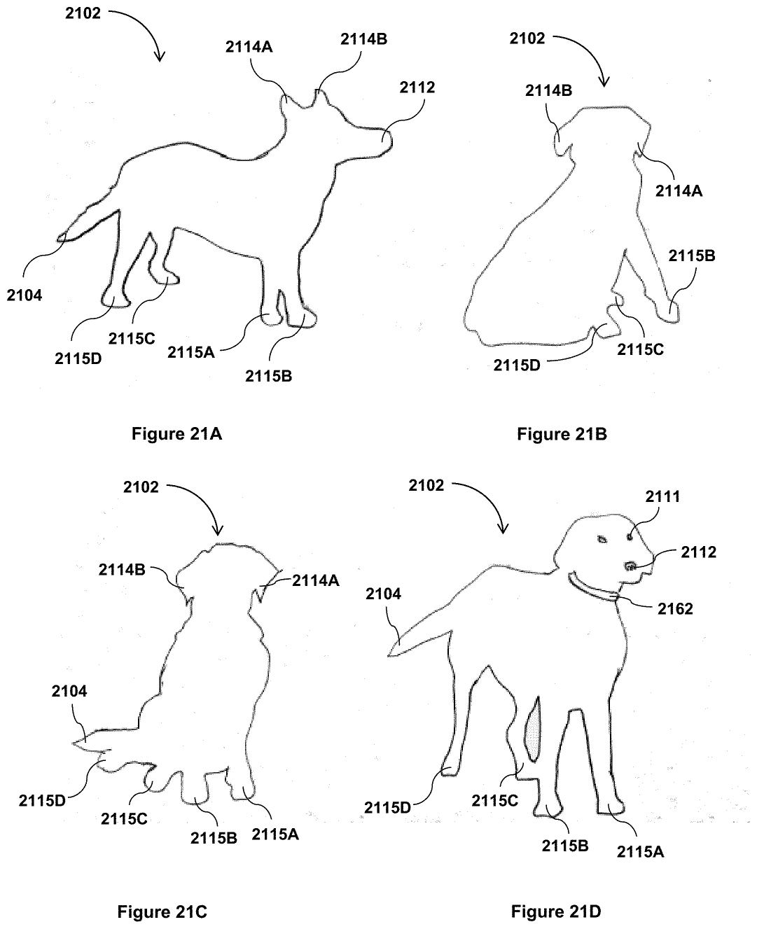

Turning to FIGS. 21A-21D, we see depictions of a dog 2102. In FIG. 21A, the dog's ears 2114A, 2114B, nose 2112, tail 2104 and legs/paw 2115A-2115D are depicted. In FIG. 21B, the dog 2102 is depicted facing away from the viewer, showing the ears 2114A, 2114B, the back 2118, and paws 2115B-2115D. In FIG. 21C, the ears 2114A, 2114B, the tail 2104, and paws 2115A-2115D are depicted. In FIG. 21D, the eyes 2111, the nose 2112, the tail 2104, the legs/paws 2115A-D and the dog's collar 2162 are seen.

A key task is differentiating between foreground and background. In one aspect, structured light may be projected onto the field in order to gauge distance. A description of structured light is contained with U.S. Pat. No. 6,549,288, which is incorporated herein by reference as if set forth in full. An additional discussion of structured light in the context of the Microsoft® Kinect® is found at http://users.dickinson.edu/˜jmac/selected-talks/kinect.pdf. In addition, one of the instant inventors describes an additional method for determining depth in U.S. Pat. No. 9,325,891, which is incorporated herein by reference as if set forth in full. Additionally, dual camera binocular vision and light field photography (such as Lytro) may be utilized to determine relative distance of objects.

At a high level, we begin with a raw image of a dog, and identify the things in the image that are dog and not dog. In one aspect, a dog texture and a non-dog texture may be identified. An algorithm may initially determine the area that is dog, subject to clean-up. For the purpose of identifying posture, it is not necessary (in most cases) to precisely identify the edges of the dog. Indeed, a smoothed outline may be as effective or more effective in determining posture. As can be seen in FIGS. 21A-21D, a simplified, smoothed image of a dog is sufficient in certain cases to determine posture.

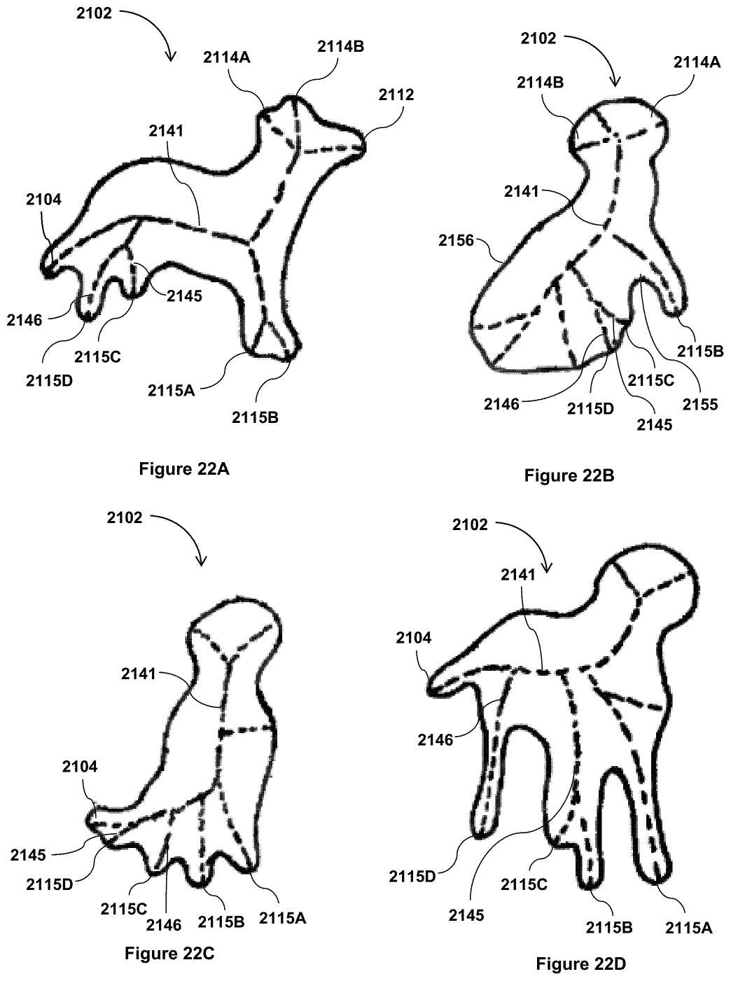

In other instances, simple skeletal imaging may be used alternatively or in addition to smooth outline images to determine posture. Referring now to FIGS. 22A-22D, skeletal images of the dog 2102 of FIG. 21A-21D can be seen. Each of the skeletal images 22A-22D corresponds to smooth outline images 21A-21D, and the same elements may be identified. For example, the ears 2114A, 2114B, nose 2112, tail 2104 and legs/paws 2115A-2115D can be seen in the skeletal image of FIG. 22A. However, in the smooth outline image of FIG. 21A, the dog's ears are much more distinguishable than the ears in skeletal FIG. 22A. Similarly, the ears 2114A, 2114B are much more distinguishable in the smooth image of FIG. 21B, than the ears 2114A, 2114B in FIG. 22B, which are almost indistinguishable.

On the other hand, in the skeletal view of FIG. 22C, the dogs paws, 2115A-2115D and tail 2104 are more distinguishable than in the smooth outline view of FIG. 21C. Thus, depending on the position, posture, angle at which an image is taken, background objects and/or colors, etc., a skeletal view in lieu of, or in addition to, a smooth outline image may be used to determine posture of an animal.

In addition, skeletal views may show skeletal structure. For example, in FIGS. 22A-22D structural lines 2141, 2145 and 2146 may be seen. Lines 2141, 2145 and 2146 may approximately match the curvature of the outer edge of the object and thus, help to identify features of the object.

In one aspect, a filtering operation may be invoked to remove elements that do not contribute to posture identification. In one aspect, the closest dog may be selected if there is more than one dog in the image. One goal of a filtering operation may be to determine the shape of the body underneath the fur. As is familiar to anybody who has owned a long-haired dog, the distance between the end of the hair and the skin can be large, as dramatically illustrated by the apparent shrinking of the long-haired dog when the hair gets wet.

Ultimately, it may be desirable to determine the skeletal position of the dog. The position of the bones cannot easily be directly measured, but can be determined utilizing inferences drawn from other data gathered as described herein. Direct measurement of bone position may be made utilizing x-ray technology, sonar and/or ultrasound technology, and/or MRI technology.

In another aspect, joints (including jaws) frequently make a noise when moved. Sometimes this noise is integral to the joint itself and other times, such as with jaws, it may include a secondary sound, such as the teeth touching. Embodiments of the present invention may be implemented in one aspect using integral sound alone, in another aspect using secondary sound alone, and in a third aspect using a combination of integral and secondary sound. In particular, as an animal ages, the joints are more likely to generate integral noise. By utilizing a single microphone, the proximity of the animal may be estimated by isolating the joint noise associated with one or more joints, measuring the volume, and calculating distance from the microphone. In one aspect, the sound of each joint may be identified by correlating movement of that joint with manually entered data and/or video data and/or other sensor data. After identifying an appropriate fingerprint to uniquely identify that joint (optionally as compared to other joints on animals in or about the device), triangulating the unique sound of a specific joint may be utilized to locate the joint and/or track joint movement.

In another aspect, one or more of a plurality of microphones may be used to identify the joint making a noise, and the plurality of microphones then may be used to triangulate the location of that joint. Identification of the joint making the noise may be done, in one implementation, by training the device. One method for training the device is to manually identify the joint being moved either in real time or in a recorded and played-back session. Another method is to utilize video sensor(s) in combination with audio sensor(s) to associate a particular movement with a particular sound or combination of sounds. In one aspect, this may be the movement of a single joint, such as a dog lifting a paw. In another aspect, this may be a larger movement involving multiple joints, such as a dog sitting. In another aspect, the system may be recalibrated periodically to account for changes as a dog ages.

In many instances, for training purposes or otherwise, it is beneficial to identify the posture of an animal from an image (e.g., whether an animal is setting or standing). As used herein, the word “posture” refers to the position in which an animal holds its body, and at times, is used interchangeably with the word “position.” Unless the context requires otherwise, use of the word “position” should be understood to refer to “posture” and conversely, “posture” should be understood to refer to “position” of the animal.

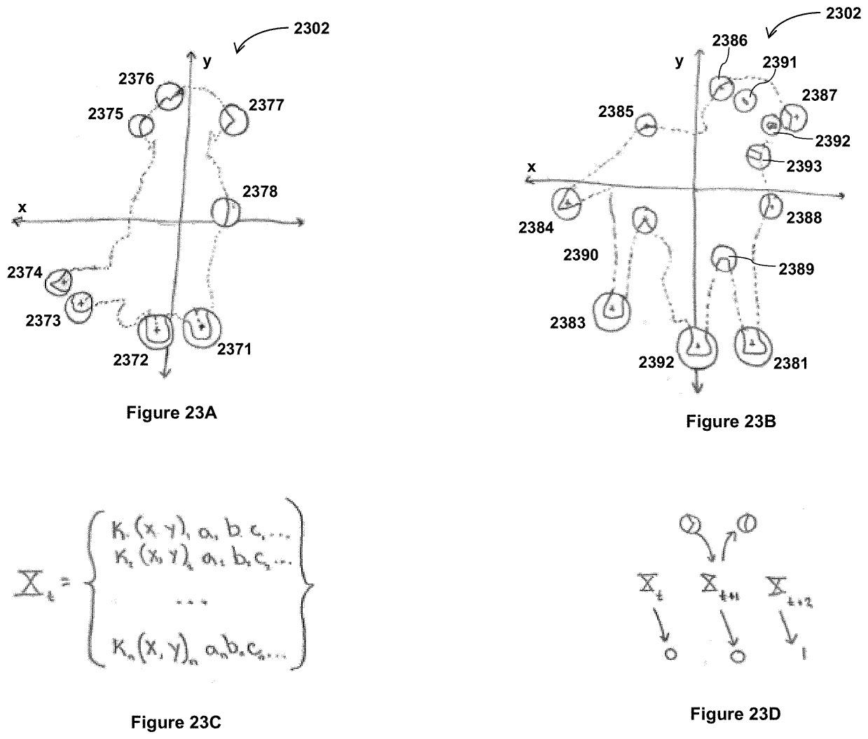

Referring now to FIG. 23A-23B, therein are shown outline views of a dog 2302, in two different postures. Specifically, FIG. 23A shows the dog in a sitting posture, and FIG. 23B shows the dog in a standing posture. Both figures show regions/features (e.g., a curved feature, a pointed feature, etc.) that may be used for posture identification. FIG. 23A show regions 2371-2378 and FIG. 23B shows regions 2381-2393. The number of regions may vary from image to image, posture to posture, and may also depend on the type of animal, breed, height, weight, body mass, etc. Also shown in FIGS. 23A and 23B, are x and y axes so that each region may be classified by a point (x, y) in the two-dimensional space of the image.

Initially, each region of an image is fit into a feature classification “K”, which may be modified at a later time, after additional data is gathered. Thus, at a given instance in time “t”, the regions may be expressed mathematically. For example, region 2371 may be expressed mathematically as K₁(x,y)₁,a₁,b₁,c₁ wherein K₁ represents the feature classification of region 2371, (x,y)₁ represents the coordinates of region 2371 along the x and y axes, and a₁, b₁, c₁ represent characteristics or properties of the feature of region 2371 (e.g., velocity, deformation, temperature, color, etc.). A list of possible characteristics or properties of features is provided below with regard to the discussion of code implementing certain aspects of the invention. Similarly, region 2372 may be expressed mathematically as K₂(x,y)₂,a₂,b₂,c₂ wherein K₂ represents the classification of the feature of region 2372, (x,y)₂ represents the coordinates of region 2372 along the x and y axes, and a₂, b₂,c₂ represent characteristics or properties of the feature of region 2372. Each of the other regions 2372-2378 of FIG. 23A, and regions 2381-2392 of FIG. 23B may be likewise expressed mathematically. Thus, a mathematical representation of the collection of features/regions of an animal (or object) “X” at a given point in time “t,” may be expressed as shown FIG. 23C, wherein “n” represents the number of regions in the given image.

Also, in many instances, it is beneficial to identify when the posture of an animal changes. Such posture changes may help to identify or confirm features and/or may be used to modify the initial classification of a feature. For example, in some instances it is useful to identify when an animal has gone from a sitting to a standing posture (i.e., from the posture of FIG. 23A to the posture of FIG. 23B). Such posture changes may be identified through a series of images over time.

FIG. 23D is a schematic representation of a time series of features used for identifying when the posture of an animal has changed (e.g., from sitting to standing). Xₜ represents a collection of regions/features (e.g., the collection of regions of FIG. 23C) at a given point in time “t”. At the point t, there are no new features, and the “O” indicates that no determination has been made that the animal is standing. Xₜ₊₁ represents another collection of regions of an image at another point in time “t+1”. In the example of FIG. 23D, at the point in time t+1, a new feature is identified and an existing feature is removed. However, at point in time t+1 the changes are not enough to make a determination that the animal has gone from a sitting posture to a standing posture. Xₜ₊₂ represents another collection of regions of an image at a point in time “t+2”. At time t+2, no new features/regions have been added, and no existing features/regions have been removed. However, the properties (e.g., properties a, b and c of FIG. 23C) of the feature or region may have changed so that a determination may be made that the animal is now standing. The determination is represented by the “1” in FIG. 23D. Examples of properties that may have changed that may indicate standing may include, but are not limited to, position, acceleration, deformation, etc.

In some instances, a classification algorithm is used to make the initial classification of a feature or region and such algorithm may be adjusted over time with a supervised learning technique. For example, if a region is initially classified through the classification algorithm as a shoulder, but later is determined to be an ear, the initial classification algorithm may be adjusted so as to determine, in more instances, that the initial classification should be an ear.

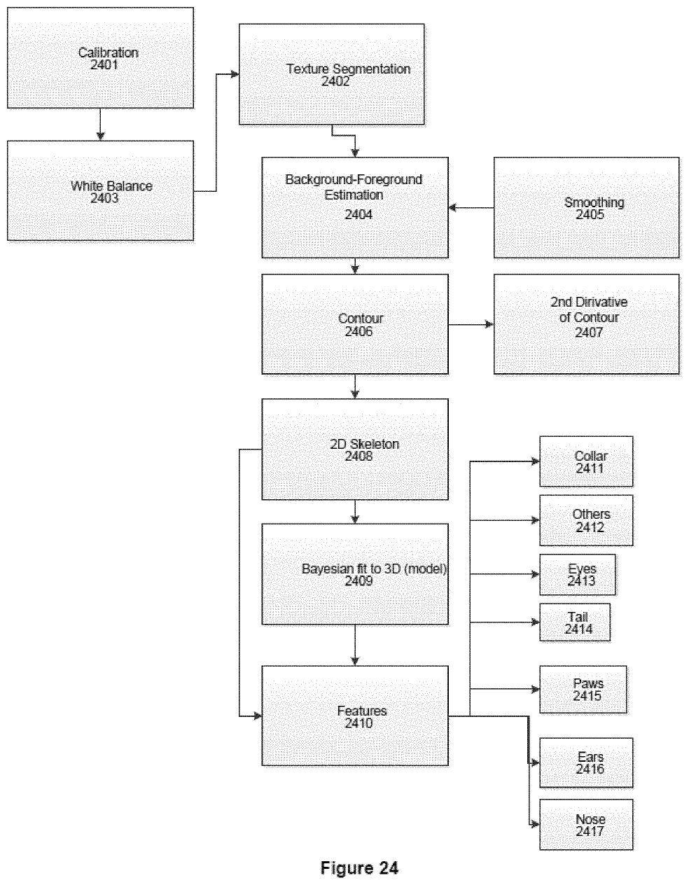

Turning now to FIG. 24, an illustration of a method for recognition of features of an animal from an image is shown. Optional steps of the method include calibration 2401 of the imaging device and obtaining a proper white balance 2403. Although not illustrated, calibration of a FLIR device may include a temperature calibration. After an image is generated, the method comprises, at step 2402, analyzing the image to determine texture segmentation, and at step 2404, estimating the background and foreground areas utilizing the techniques disclosed herein. In one aspect, there is a binary determination (e.g. “area at approximately the distance of the dog” and “area not at approximately the distance of the dog”). In another aspect, the determination may be of differing granularity, ranging from binary in some cases to a highly precise distance estimation for each pixel and/or area and/or texture zone and/or temperature zone within the image.

At step 2405, the image is smoothed. While the smoothing step 2405 is optional, in many implementations it will be utilized to simplify and/or increase the accuracy of the identification of the animal's body parts and positions. At step 2406, the portion of the image comprising the dog is analyzed to determine contour. In one aspect, a grassfire transform may be performed to compute the distance from pixels interior to the dog to the border of the dog to yield a skeleton or medial axis. In one implementation, a virtual “fire” is used to burn in from the edges in order to identify the central structure. Referring again to FIG. 22A-D, lines 2141, 2145 and 2146 are examples of what remains after the edges are “burned”. In another aspect, it may be described as identifying the locus of meeting waveforms.

A highly simplified pseudocode implementation of a grassfire transform is shown below. This pseudocode is drawn from https://en.wikipedia.org/wiki/Grassfire_transform, last visited on Oct. 21, 2016:

for each row in image left to right

for each column in image top to bottom

if(pixel is in region){

set pixel to 1 + minimum value of the north and west
neighbors

}else{

set pixel to zero

}

}

}
for each row right to left

for each column bottom to top

if(pixel is in region){

set pixel to min(value of the pixel, 1 + minimum value of

the south and east neighbors)

}else{

set pixel to zero

}

}

}

At step 2408, a 2-D skeleton of a shape is generated constituting a thin version of the original shape that is equidistant to its boundaries using a related technique of a topological skeleton. This technique may incorporate grassfire transform, centers of maximal disks, centers of bi-tangent circles, and/or ridges of the distance function.

In another aspect, curvature may be utilized to determine shape. For example, point 2155 of FIG. 22B has a high level of curvature, while point 2156 has a low level of curvature. The curvature may be utilized to generate inward-propagating division lines that follow the curvature. For example, lines 2141, 2145 and 2146 approximately match the curvature of the outer edge of the animal (or object). These internal areas may be called “knobs”. The knobs may be determined by analyzing, at step 2407, the second derivatives of the curves/contours. In some aspects third derivatives of the curves/contours may also be also be analyzed. By doing such analysis, the outer contour of the animal (or object) may be determined. In addition, the knobs may be analyzed in combination, such as in groups. Properties of the groups may be utilized to further refine the contour.

In another aspect, the points of maximum curvature may be utilized to underlie additional operations. These operations may be based on the (x,y) coordinates of regions (e.g., the regions 2371-2378 of FIG. 23A). It may be desirable to append a depth, or “Z” value, generating X-Y-Z coordinates for regions. Movement of the regions and/or knobs and/or curves over time may be utilized to further refine the curvature identification operation.

In some embodiments, at step 2409, two dimensional data (or two dimensional data with some additional depth information) may be fit to a three-dimensional model utilizing Bayesian logic, and then features of the are animal determined at step 2410. In other embodiments, a determination of features is made based on the two-dimensional skeleton shape generated at step 2408. Features include collar 2411, eyes 2413, tail 2414, paws 2415, ears 2416 and nose 2417 and may include other features 2412.

In one aspect, analysis is initialized on one or more features and those features are tracked over time (see e.g., FIG. 23D showing a schematic representation of changes over time to regions/features). As the dog changes posture over time, one or more of the regions, knobs, curves and/or features may move, appear or disappear. Such changes may be utilized to identify contours, features and/or posture.

In another aspect, an algorithm identifies features worth tracking (such as the “+” marks in FIGS. 23A and 223B). Information is then aggregated from that plurality of features. In a preferred implementation, these features are tracked over time. Thus, for example, if the tail (e.g., 2374 of FIG. 23A is a feature being tracked, and the tail is in different positions in different frames (e.g., the position shown by 2384 of FIG. 23B), an inference may be drawn that the tail is wagging and/or that the animal is moving. By measuring the movement or lack of movement of other features, the actual animal activity may be identified with greater specificity. In this implementation, it is desirable to have depth data to measure movement in all three dimensions.

For the purposes of this discussion, elements of interest are described as a “component”. Components may be identified as follows: A skeletal computation (as described above) may be identified. In a preferred implementation, the skeletal depiction is smoothed. A radius is identified around one or more components. As the components move relative to a fixed point and/or relative to each other, posture and posture changes may be identified.

The salient protruding elements and/or components may be identified and tracked, and their properties measured.

Pseudocode implementing certain aspects of the invention may look similar to the following:

bag of contours gesture tracker
=========================
im = get_image( )
scale_estimator.update(im, last_contour)
smoothing_scale = scale_estimator.estimate( ) / 20
mask = estimate_smoothed_silloette(smoothing_scale)
countour = fit_splines_to_region(mask)
bag.assign_closest_fit( detect_new_features(im, mask, countour))
for k in bag.features( ):

k.position.update(im, contour)
k.velocity.update(im, contour)
k.deformation.update(im, contour)
k.history.append(k.classify(context=features))

k.prune(quality_thresh)
posture_estimate.update(features)

While position, velocity, deformation and history are shown in the pseudocode, other characteristics/properties may be measured and/or utilized. These include, but are not limited to:

Temperature (including changes, relationship to ambient temperature, and temperature when compared to other regions);

Sound (including triangulated sound location and/or sound characteristics and/or changes to sound);

Color;

Brightness;

Obscuration status;

Disappearance and subsequent reappearance in a time sequence;

Reflectivity;

The “Grain” or hair/fur/skin/clothing texture/other direction (so for example, the fur on a tail may run parallel to the tail and the fur on a leg may run parallel to the leg, so when three elements are present and likely to be two legs and a tail, the “odd man out” or tail can be identified because the legs are likely to be more parallel to each other than the tail is, causing the fur grain to run differently);

Microexpressions;

Micromovements, such as a pulse or heartbeat;

Larger movements, such as breathing, wagging, panting, or chewing;

Presence or movement of debris and/or particles and/or small objects (for example, skin will not shed while fur will, so an area that is dropping small linear things is more likely to be covered with fur than an area that is not; for further example, food crumbs or dripping water or drool may all be debris falling from, or located in or around, the mouth; for further example, a round object falling from a point on the dog and then bouncing will almost certainly represent a ball dropped from the dog's mouth);

Size change, for example the slight increase in chest girth associated with inhalation or the change in size associated with erectile tissue.

A database is maintained that clusters data from dogs in certain positions. For example, a cluster of data for all dogs that are squatting may be created. The database may contain one or more of medians, averages, modal, or other position data for various data points. The database may further cluster within groups that are similar. For example, if dogs with hip dysplasia sit in a manner distinct from healthy dogs, there may be a separate cluster for dogs with hip dysplasia. The clusters may be done in the space within which the attributes are defined. Furthermore, the database may contain individual entries related to individual animals, and may contain clusters based on size, breed, age, weight, or other characteristics.

In some aspects, it is desirable to create a two dimensional skeleton (such as via the grassfire technique described above) in order to determine where and how much data is needed from the depth map. The addition of a third dimension can substantially improve the signal to noise ratio.

In one aspect, a balance is achieved between data analysis and speed. For example, a two dimensional skeleton is far less computationally difficult to analyze than a three dimensional skeleton. In one implementation, a certainty measurement is identified, and once the position of the animal is identified with sufficient certainty, the analysis may conclude. Alternatively, or in addition, the amount of analysis necessary and/or the data points necessary to reach that certainty level are saved in a data structure. This data may then be averaged or otherwise combined with other data, or kept separate, and used to determine what data should be gathered for similar tasks in the future.

In one aspect, confidence scores are determined. For example, 0.4 sitting, 0.6 squatting. In some aspects, similar positions may be treated similarly. This is particularly useful when an animal moves from one state to another, such as moving from sitting to squatting. The confidence score may be utilized to generate a probability estimate that the animal is in a particular position.

In another aspect, analog features may be utilized. For example, the distance from a paw to a fixed point. This may be tied to an analogue cue, such as a rising pitch of sound.

In another aspect, reflectivity may be utilized to identify a fixed position on the dog. Nails, paws, skin, nose, eyes, and fur all have different reflective properties. Similarly, accoutrements, such as a collar, a tag, or a coat, may be identified. In addition, a signal may be emitted from the accoutrements that may be utilized to more positively identify them. The signal may be audio, visible, radio, NFC, Bluetooth LE, or otherwise.

In one aspect, one or more dyes may be utilized to make certain portions of an animal more easily identifiable. While the dye may be visible to humans, it may also be preferable to utilize a non-visible dye. Human vision sees approximately from 400 nm (below which is ultraviolet) to 700 nm (above which is infrared). Many camera sensors are capable of perceiving light outside of the human visual range, and indeed in many cases a filter is required to prevent light outside of the human visual range from interfering with the photograph. Dyes exist that reflect light outside of the human visual range.

In an example, a kit with six dye colors may be made available. Each color is associated with a certain part of the dog. For example, if the dye colors are A, B, C, D, E and F, A may be right front paw, B may be left front paw, C may be right back paw, D may be left back paw, E may be back of the neck, and F may be base of the tail. Optionally, a warning system may be deployed whereby the visual sensor is operably connected with a notification system (such as a warning light, a signal sent to a portable device, or otherwise) that advises the human operator that one or more of the dyes is no longer reflecting sufficiently and needs to be reapplied. In one aspect, the sensor may also transmit light in one or more frequencies that the dye reflects.

In another aspect, dogs have different levels of oils and other exudates in their fur, fur color differs over the areas of the animal, and skin characteristics differ over areas of the animal. These levels differ between dogs and within the different areas of the same dog. In one aspect, reflectivity differentials, spectrographic analysis, and/or other measurements of the fur may be utilized to differentiate areas of the dog, identify where non-contiguous areas of the dog are visualized in a contiguous manner (for example, a dog sleeping with the back right leg touching the chin), or to provide other data.

There are certain features that remain relatively constant across a morphological diversity of animals. For dogs, for example, eyes are quite consistent, as is the nose. Other features, such as a collar, tail, paws, tongue, and ears may be less consistent across a morphological diversity of dogs. However, within a subgroup of dogs, there may be consistency. For example, terriers may have ears that are similar to each other.

In one aspect, the center of mass is sought out and the data points may be consistent relative to the center of mass. Similarly, the collar may be sought out and the data points measured relative to the collar.

It should be understood that posture recognition is quite different from face recognition in that facial recognition assumes a position of the face within a relatively tight range of constraints. For example, the relationship between the pupils cannot be measured if one pupil is not visualized. By contrast, the position and posture of the dog can be measured, utilizing these inventions, without making an assumption as to the range of constraints for the angle of visualization.

The transition from one posture to another posture may be utilized to determine the first and/or second postures of the animal. As an example, imagine a standing dog sits down. The movement—a lifting of the head and tail, non-movement of the front paws, folding of the back paws against the back of the dog, the dropping of the back of the dog, all point to a movement from standing to sitting. This movement may be utilized to identify features of the dog that may then be tracked. Indeed, even without tracking, certain characteristics of those features—reflectivity, absolute temperature, relative temperature, color, size and shape—may be recorded and utilized to reacquire or help to acquire those features at a later time.

Dogs also engage in habitual behavior. For example, a dog may habitually sleep on the top ledge of a sofa. In one aspect of the inventions, features of a dog, once acquired, may be tracked to various resting or activity places that a dog habitually visits. The profile of the features of the dog may be analyzed relative to the place (in this case, a sofa) where the dog frequently rests. Because we know the location of the feature, for example a paw, at the time of the analysis, even a relatively close match in color may be sufficiently identifiable as to later differentiate the paw from the sofa because the system has stored data describing the relationship between the appearance of the paw and the sofa.

In many cases, an insufficient number of features may be identified to bring the estimated dog posture to within a desirable confidence interval. It may be desirable to measure the rate and direction of change of those features (as described with regard to FIGS. 23A-23D above), which may provide the additional data needed to narrow the confidence interval. For example, if a dog's paw has been recognized, if the change in the position of the paw is that it is rising, it can be inferred that the dog's behavior is moving from a position with a lower paw to one with a higher paw. This movement may be checked against a database to determine the most likely positions that are compatible with such a movement. If we are 50% certain that the dog is in a position where it is about to jump and 50% certain that the dog is in a position where it is about to sit, knowing that the paw is moving up may change the confidence interval to 95% certainty that the dog is about to jump.

In addition, movement of one or more features may be sufficient to serve as a training cue. For example, if the CLEVERPET® device has been programmed to emit an unpleasant warning sound if the dog begins to squat (in preparation to urinate in the house), it may be unclear whether the dog is starting to sit or squat. By measuring the change in the tail, which falls to meet the floor, the likelihood that the dog is about to sit is significantly increased, making the device less likely to emit the warning sound.

To train the system, it may be desirable to create 3D (or 2D) models of various dogs with varying morphologies. Each of the models may have a different posture and parameter. The system would then look for similarities between the dog being monitored and the database. As the system identifies more similarities, the system identifies one or more models that apply best to the dog. In one aspect, the database may be populated by measurements of actual dogs against a known background, with dye markings, with human monitoring, or with other mechanisms for correlating the model with the actual posture of the dog to within an acceptable confidence interval. In another aspect, the system may be programmed to accept a dog breed or morphology data point or data points, allowing it to compare the dog's behavior against a subset of the database.

In another aspect, the system may be initially trained by manually identifying features of the animal. For example, the camera sensing system (in this example, we will use a two-camera system—visual light and FLIR) may generate multiple images and send them to a human interaction device. The human would then click on (or otherwise identify) certain features. The system may ask for the human to click on the nose, then the ear, then the paw, etc. By gathering this data, coloration-specific and morphology-specific aspects of the dog may be utilized to improve the accuracy of the system.

An additional consideration is that dogs are analog—they exist in a world of incremental changes, grey areas, and ranges. By contrast, computerized analysis takes place on a digital system. Accordingly, the input data should be viewed as analog—for example, we should expect the paws of the same dog when sitting to be slightly different distances at different times. Similarly, the output data for use by the dog, for example a rising tone used to train the dog, should be output in an analog manner that is more easily understood by the dog.

The use of analog training methods may be utilized to reward, and thus train, dogs who take certain positions in response to analog signals (which may be digitally generated but appear to the dog as analog). For example, a dog may be trained to hold certain positions when certain sounds are played, allowing a dog to be led through various dog yoga positions. In a simple example, one cue (such as a tone) may indicate downward dog and another upward dog positions.

It should be understood that once a state has been established as likely (for example, a 90% chance that a dog is standing), even if the dog moves, the dog is likely to still be standing unless it has engaged in a behavior that indicates that it is changing posture. If the standing dog turns around, for example, and we therefore lose visualization of certain features and the still image generates a confidence level of only 20% that the dog is standing, the dog may still be assumed to be standing so long as contrary data has not been received. This may be utilized in reverse—using a high probability position identification to infer position earlier in the measurement session.

Markov, POMDP (Partially observable Markov decision process), and/or a Kalman filter, among others, may be utilized in conjunction with these inventions.

POMDP may function as follows (as described at https://en.wikipedia.org/wiki/Partially_observable_Markov_decision_process, last visited Dec. 29, 2016):
A discrete-time POMDP models the relationship between an agent and its environment. Formally, a POMDP is a 7-tuple (S, A, T, R, Ω, O, γ), where
   S a set of states,
   A is a set of actions
   T is set of conditional transition probabilities between states,
   R: S×A→ [symbol] is the reward function.
   Ω is a set of observations,
   O is a set of conditional observation probabilities, and
   γ∈[0, 1] is the discount factor.
At each time period, the environment is in some state s∈S. The agent takes an action a∈A, which causes the environment to transition to state s′ with probability T(s′, a). At the same time, the agent receives an observation o∈Ω which depends on the new state of the environment with probability O(o|s′, a). Finally, the agent receives a reward equal to R(s, a). Then the process repeats. The goal is for the agent to choose actions at each time step that maximize its expected future discounted reward:

$$E [ {\sum }_{t = 0}^{∞} {γ}^{t} {r}_{t} ] .$$

The discount factor γ determines how much immediate rewards are favored over more distant rewards. When γ=0 the agent only cares about which action will yield the largest expected immediate reward; when γ=1 the agent cares about maximizing the expected sum of future rewards.

Animal movement may change as their health condition changes. For example, the amount of transition time between standing and sitting posture may increase from one second to five seconds. These changes are normally gradual when correlated with age, and the system can be programmed to adjust its database or other parameters to adjust to those changes. More rapid changes may be an indication of a health issue for the dog. For example, a sudden cessation of jumping activity, a sudden increase in the amount of time it takes to sit, or a sudden decrease in the amount of time spent standing may all indicate a health change. In such a case, one of the notification systems described earlier may be utilized to notify the dog's caretaker of the situation, optionally in conjunction with a database-driven list of possible causes.

Indeed, even poor posture may be identified and the owner notified of that. Alternatively (or in addition), the CLEVERPET® Hub or another system may train the dog to improve their posture.

Hair contour rejection may be modified based on the size of the dog and the length of the dog's hair. In one aspect, the temperature of the fur decreases with distance from the body, indicating how long the hair is and informing the hair rejection algorithm.

In one aspect, a known element in the environment may be utilized to measure the animal against. For example, the CLEVERPET® Hub may be utilized for white balance calibration, illumination measurement, or other camera calibration tasks. Similarly, because we know that when a dog eats from the hub, the eating is done with the mouth, a dog's features may be better identified based on that known data point.

The number of pixels captured and analyzed impacts the amount of processing power required, and the quality of the results. In one aspect, the number of pixels is modified to obtain different result quality or power utilization.

For certain behaviors, the confidence interval required may be lower. For example, if there is a greater than 40% chance that the dog is squatting in preparation to urinate, a warning tone may be issued.

Without limiting the foregoing, certain implementations may be claimed as described below.

A computer-implemented method for detecting animal position, comprising: imaging an animal using at least a forward-looking infrared camera (“FLIR camera”); detecting parts of the animal not covered by fur by eliminating areas that are a similar temperature to ambient temperature; and identifying eyes, nose, mouth, ears, and other areas by looking for the shapes and/or relationships between areas and/or location relative to each other and/or the temperature of the elements. Taking FIG. 15 as an example, the nose 1512 (which in dogs may be wet) is darker, and therefore colder, than the ambient fur temperature. Similarly, the mouth 1513 is brighter than the ambient temperature and fur, slightly brighter than the inner ear 1514, all of which are dimmer than the eyes 1511. FIGS. 17 and 18 also show dogs, and show the same relative temperatures as FIG. 15. Comparing the dogs in FIG. 15 and FIG. 17 with the human in FIG. 20, one can observe that exposed areas of skin 2018A and nose 2012 are brighter (and therefore hotter) than portions of the face 2017 that is covered by hair, or portions of the body (e.g., upper chest 2018C) covered by clothing. However, sufficiently thin clothing in contact with the body, such as a thin t-shirt results in areas that are warmed and therefore differ significantly from the ambient temperature. It should be noted that areas with thinner fur may show higher temperatures than those with thicker fur.

Animal-Driven Gaming

Canine behavior is different than human behavior. In addition, the interactions that dogs have with each other are very different from the interactions humans have with dogs. As the CLEVERPET® Hub and other interactive pet devices become more common, it is desirable to create games and activities that dogs find suitable and interesting.

Until now, humans have developed the toys and games we use with dogs. Dogs play with other dogs, but until now have not been able to program the toys and games that humans provide them. In this disclosure, we enable dogs to modify an interaction device.

In one aspect, a dog may interact with a CLEVERPET® Hub (“Hub”). While the Hub is used as an example, it should be understood that other devices may be utilized. Using the first generation Hub, there are three capacitive touch sensors connected to a CPU, memory, and food delivery system. Criteria are set for one or more of time, complexity, speed, and other characteristics. The dog is then rewarded for interacting with the Hub in a manner that meets one, more, or all of the set criteria.

The dog is now free to interact with the hub without attempting to emulate the patterns that a human has created. As an example, a dog may become frustrated and scratch rapidly and alternatively, right front paw on the right pad, left front paw on the middle pad. If these actions meet the criteria, they are recorded as a new target behavior. The pattern becomes a target game, and the next time the dog engages in that behavior, the dog receives a reward.

The new game may be shared over a network and utilized for other dogs. Characteristics of games created by dogs may be averaged and/or combined in order to create new games. Similarly, aggregation may be done within subsets of animals, such as “large dogs”, “terriers”, etc.

Utilizing the technology described herein, or other technology as appropriate, the posture of a dog may be utilized to generate new games. Posture, sound, and/or interaction with one or more devices may be used individually or in any combination as the basis for a new game.

In one aspect, similar toys may be provided to multiple animals. For example, a tennis ball may be presented. The dog may then be imaged dropping his head with the ball in his mouth, throwing the ball up, letting it bounce, and catching it. Other dogs may then be rewarded for engaging in a substantially similar activity.

In one aspect, the percentage (or raw number) of animals that succeed in obtaining a reward for a given animal-generated game may be utilized in determining whether the game is retained unchanged, retained modified, or rejected.

In another aspect, there may be interaction between remotely located animals wherein one animal may reward another animal. There may be communications via video, audio, scent, tactile/haptics feedback, or a combination. By actuating a button, switch or similar connected device, the first dog may cause the Hub to dispense a treat to the second dog. In a further aspect, the first dog may be required to play a game or meet criteria before being allowed to dispense a treat to the second dog. In a preferred implementation, both dogs may provide a treat to the other.

In one aspect, a virtual reality environment may be utilized for play between two animals. The environment need not be a complete virtual reality (“VR”) experience, but may include surround sound, three dimensional screens, wearable VR devices, and/or scents. In one implementation, video and/or audio, whether VR or not, may be utilized in conjunction with cameras and/or microphones to allow one dog to see and/or hear another where the dogs are not in the same room. When the first dog brings an item toward the other dog and leaves it there (and/or tosses it there and/or otherwise presents it), an animal interaction device may present a virtual or real counterpart to the second dog. In one example, the first dog drops a ball near the other dog and the ball bounces against the screen; the animal interaction device then uses a projector and/or other VR technology and/or a simple screen to show a ball bouncing toward the second dog. In another aspect, the animal interaction device may eject a ball in response. The items need not match—that is, the first dog may drop a ball near the second dog and the animal interaction device may then project a laser for the second dog to chase. In another aspect, the second item may be a treat, food, sound, light, and/or smell. In another aspect, the first dog it rewarded with a treat, food, sound, light and/or smell in response to presenting the ball or other toy or food to the second dog.

### MISCELLANEOUS

The various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

For example, the various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an Application-Specific Integrated Circuit (ASIC). The ASIC may reside in a CLEVERPET® Hub, dog-borne device or other system element. In the alternative, the processor and the storage medium may reside as discrete components in a CLEVERPET® Hub, dog-borne device or other system element.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any non-transitory medium that facilitates transfer of a computer program from one place to another. A storage media may be any available media that can be accessed by a general purpose or special purpose computer. By way of example, and not limitation, such computer-readable media can comprise RAM, ROM, EEPROM, CD-ROM, DVD, Blu-ray or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Disk and disc, as used herein, includes but is not limited to compact disc (CD), laser disc, optical disc, digital versatile disc (DVD), solid state disks, solid state memory devices, USB or thumb drives, magnetic hard disk and Blu-ray disc, wherein disks usually reproduce data magnetically, while discs reproduce data optically with lasers. Combinations of the above should also be included within the scope of computer-readable media.

Processes performed by the CLEVERPET® Hub, dog-borne devices, or system nodes described herein, or portions thereof, may be coded as machine readable instructions for performance by one or more programmable computers, and recorded on a computer-readable media. The described systems and processes merely exemplify various embodiments of enhanced features. The present technology is not limited by these examples.

While the various embodiments have been described in connection with the exemplary embodiments of the various figures, it is to be understood that other similar embodiments may be used or modifications and additions may be made to the described embodiment for performing the same function without deviating therefrom. Therefore, the present invention should not be limited to any single embodiment.

What is claimed is:

1. An animal exercise apparatus, comprising:
at least one reward dispensing device located in an animal-accessible area;
at least one camera located in a first area;
a controller in communication with the camera and the reward dispensing device that estimates a level of activity of an animal and increases or decreases exercise provided to the animal by dispensing or withholding rewards from the reward dispensing device.

2. The animal exercise apparatus of claim 1, where the level of activity is estimated by an animal-borne device.

3. The animal exercise apparatus of claim 1, where the level of activity is estimated by the at least one camera.

4. The animal exercise apparatus of claim 1, where the level of activity is estimated using a computer vision system.

5. The animal exercise apparatus of claim 1, where the level of activity is estimated through a calculation that incorporates the animal's age.

6. The animal exercise apparatus of claim 1, where the level of activity is estimated through a calculation that incorporates the animal's weight.

7. The animal exercise apparatus of claim 1, where the level of activity is estimated using a time-of-flight sensor.

8. The apparatus of claim 1, where the level of activity is estimated using a depth camera.

9. The apparatus of claim 1, where the level of activity is estimated using data from a collar on the animal.

10. The apparatus of claim 1, where the level of activity is estimated using information from at least one camera in a second area.

11. The apparatus of claim 1, where the controller increases or decreases the exercise provided to the animal in order to reach a particular caloric goal.

12. The apparatus of claim 1, where a level of exercise provided to the animal can be set by an operator.

13. The apparatus of claim 1, where the level of activity is continuously reported to a remote computer.

14. The apparatus of claim 1, where the level of activity is intermittently reported to a remote computer.
